(19) United States
(12) Patent Application Publication
(10) Pub. No.: US 2015/0234805 A1
(43) Pub. Date: Aug. 20, 2015

(54) System and Method for Interacting with Event and Narrative Information As Structured Data

(71) Applicant: David Allan Caswell, Los Angeles, CA (US)

(72) Inventor: David Allan Caswell, Los Angeles, CA (US)

(21) Appl. No.: 14/624,000

(22) Filed: Feb. 17, 2015

Related U.S. Application Data
(60) Provisional application No. 61/966,661, filed on Feb. 18, 2014.

(51) Int. Cl. G06F 17/27; G06F 17/30; G06F 17/28

(52) U.S. Cl. CPC G06F 17/274; G06F 17/2785; G06F 17/2845; G06F 17/30654

(57) ABSTRACT

Systems and methods for storing, retrieving and interacting with events and narratives as structured data. Events from the real world, or from fictional story worlds, are structured using definitions of classes of events, each described by a verb concept, a set of related event roles, and a set of descriptive natural language phrases. Individual events are recorded as members of a class of events by indicating noun concepts that occupy each event role, such as specific characters, entities, locations, information artifacts, other structured events or other structured narratives. Narratives are structured using ordered sets of references to structured events, with each reference assigned an importance value and an optional reference to another, more detailed, structured narrative. Structured events are also linked to media elements such as text descriptions in different languages, images and videos that describe the structured event and enable communication of the structured narrative in different ways.

### CROSS-REFERENCE TO RELATED APPLICATIONS

The present application claims the benefit under 35 U.S.C. 119(e) of U.S. provisional patent application No. 61/966,661 entitled “System for Capturing, Storing, Navigating, Accessing and Applying Narrative Information” filed on Feb. 18, 2014, which is hereby incorporated by reference in its entirety.

### BACKGROUND OF THE INVENTION

The present invention relates in general to information processing, and in particular to the representation of event information and narrative information from the real world, or from fictional story worlds, as structured data records within a computer system, and the enabling of interaction by a human user with those structured records of events and structured narratives.

Narratives are recountings of events and are important in human communication and in human understanding. Narratives are used for many purposes, including providing reports of series of non-fictional occurrences for journalism purposes and communicating fictional scenarios for entertainment purposes. Several significant industries have evolved whose business it is to assemble and distribute fictional and non-fictional narratives, and these industries have approached these tasks by using the writing of narratives in natural language by individual humans and distributing those natural language narratives as fixed units of natural language, such as news articles, reports, scripted movies and the like.

This approach is increasingly insufficient because the quantity of, and the complexity of, event information and narrative information is increasing and is therefore more difficult to manage using fixed units of natural language produced by writing by individual humans. It is advantageous to assemble and communicate narratives in an alternative manner that is not dependant on fixed units of natural language produced by writing by individual humans, that can better accommodate the increasing quantity and complexity of event information and narrative information, and that is accessible to computer techniques.

### BACKGROUND

### Prior Art

The following is a tabulation of some prior art that presently appears relevant:

| Cit # | Pat. No. | Kind Code | Issue Date | Patentee |
|---|---|---|---|---|
| 1 | 8,515,737 | B2 | 2013-8-20 | Robert C. Allen |
| 2 | 8,688,434 | B1 | 2014-4-01 | Birnbaum et al. |

The following is a list of some nonpatent prior art that presently appears relevant:
Abelson, R. and Schank, R., Psychology Press, Scripts, Plans, Goals and Understanding (1977)
Mani, I., Morgan & Claypool Publishers, Computational Modeling of Narrative (Jan. 9, 2013)
Zarri. G. P., Springer, Representation and Management of Narrative Information (Jan. 2, 2008)

Practitioners in several academic fields have explored the structure of events and the structure of narratives using analytical techniques, including descriptions of computer systems used for research purposes by Abelson and Schank (1977), Mani (2013) and Zarri (2008). These systems have proved to be unsuitable for practical application for various reasons.

Some systems (Mani) have focused on the extraction of events and narrative information from natural language text, particularly from fictional literary natural language text, thereby requiring complex formal representations due to the extreme complexity inherent in natural language. The builders of these systems have not pursued representing events and narratives directly from the real world or from imagined fictional story worlds, and therefore remain dependant on fixed units of natural language text.

Other systems (Abelson and Schank, Zarri) have focused on attempts to model formal definitions of complex semantic activities, including their related events, within very narrow domains using complex sets of handwritten rules, and which therefore cannot be applied to general event s and general narratives. These systems are also based on extracting structure from fixed units of natural language text.

Other systems of event recording and categorization, such as timelines, chronologies, journaling and the like, have focused on capturing merely coarse representations of events that are not semantically structured and which are not arranged into narrative structures, thereby restricting their use to relatively trivial applications such as counting simple types of events, simple presentations, and the like.

Other systems have focused on the automated generation of narrative discourse in natural language text from data (Narrative Science Inc., U.S. Pat. No. 8,688,434, Automated Insights Inc., U.S. Pat. No. 8,515,737) and not on the representation of events and narratives as structured data, thereby continuing to depend upon the assembly of narratives as units of natural language text.

### SUMMARY OF THE INVENTION

Some embodiments of the present invention provide systems and methods for representing, retrieving, and interacting with general event information and general narrative information as structured data using representations of events (records of events) and narrative structures (structured narratives). General events identified in the real world, or in a fictional story world, are represented and stored using these systems and methods, and are organized as larger narrative structures that describe a sequence of represented events, that assign importance of each represented event within the narrative structure and that provide recursive encapsulation of detail about represented events as separate narrative structures. Some embodiments provide systems and methods that enable interaction with representations of events and narrative structures in beneficial ways.

In some embodiments an event and narrative server, controlled by a graphical user interface, is provided to represent general events as structured data within a records data store. These general events are represented by specifying noun concepts from a noun concept data store that fill specific event roles in relation to natural language phrases defined by a verb concept from a verb concept data store, and by the arrangement of phrases and roles being defined by definitions of classes of events from a definitional data store. Narrative structures are constructed as lists of references to represented events, with associated importance information and detail narrative information, and are stored within a structured narratives data store. In some embodiments various media elements and/or media references are attached to the representations of events and to narrative structures, and relationships between represented events are provided. In some embodiments systems and methods are provided to describe and interact with classes of narrative structures, constructed as sets of probabilistic references to definitions of classes of events and other elements.

In some embodiments systems and/or methods are provided for the automatic creation of representations of events and of narrative structures from external data stores and/or from external signals, for controlling the display of records of events on a graphical user interface, for querying representations of events and narrative structures, for locating definitions of classes of events using search techniques, for creating written natural language from represented events and narrative structures and for other purposes.

The following detailed description together with the accompanying drawings will provide a better understanding of the nature and advantages of embodiments of the present invention.

### DRAWINGS

FIG. 1. Simplified diagram of network, hardware and media.

FIG. 2. System diagram of data stores and main reference relationships.

FIG. 3. Elements of a record of an event.

FIG. 4. Elements of a structured narrative.

FIG. 5. Elements of a definition of a class of narratives.

FIG. 6. Example of a structured narrative.

FIG. 7. System and user interaction diagram for creating a record of an event.

### REFERENCE NUMERALS

100—Graphical user interface
101—Graphical user interface computer device
102—Graphical user interface input device
103—Event and narrative server
104—Event and narrative server computer device
105—Network
106—Verb-concepts computer-readable media
107—Noun-concepts computer-readable media
108—Definitional computer-readable media
109—Records computer-readable media
110—Narratives computer-readable media
111—Narratives definitional computer-readable media
200—Verb-concepts data store
201—Definitional data store
202—Records data store
203—Noun-concepts data store
204—Location noun-concepts data store
205—Structured narratives data store
206—Narratives definitional data store
300—Verb-concept
301—Verb-concept-identifier
302—One or more verbs of similar meaning
303—Verb
304—One or more verb-roles
305—Verb-role
306—Verb-role-identifier
307—Verb-role-name
310—Definition of a class of events
311—Event-class-identifier
312—Event-class-description
313—One or more event-roles
314—One or more natural language text phrases
315—Natural language text phrase
316—One or more class-categories
317—Class-category
318—Definitional-media-element
320—Record of an event
321—Event-record-identifier
322—One or more noun-participants
323—Time reference (with units and duration)
324—Event-relationship
325—Event-media-element
326—Event-media-reference
330—Event-role
331—Event-role-identifier
332—Event-role-name
340—Noun-participant
341—Noun-participant-name
350—Noun-concept
351—Noun-concept-identifier
352—Noun-concept-description
353—Primary noun-category
354—One or more noun-categories
355—Noun-category
361—Second-event-record-identifier
362—Directional-indicator
363—One or more relational-categories
364—Relational-description
400—Structured narrative
401—Narrative-identifier
402—Narrative-name
403—Narrative-description
404—Ordered plurality of event references
405—Event-reference
406—Importance-value
407—Narrative-media-element
500—Definition of a class of narratives
501—Narrative-class-identifier
502—Unordered plurality of event-class-identifiers
510—Event-class-arrangement
511—Narrative-percentage-value
512—One or more references to an event-class-identifier
513—Reference to an event-class-identifier
514—Event-class-percentage-value
515—One or more noun-concept-percentage-values
516—Noun-concept-percentage-value
517—Primary-location-percentage-value
518—Time-reference-percentage-value

### DETAILED DESCRIPTION

An embodiment of the present invention has been reduced to practice by the inventor. This embodiment is called Structured Stories and is publically available on the Internet at http://www.structuredstories.com. A short video demonstration of the operation of this reduction to practice of an embodiment is also available on the Internet, at http://youtube/0i5Sbib3q-I.

An event is an occurrence, which is something that happens or that is regarded as having happened and that occurs at a certain place during a particular interval of time. A general event is an event that is not constrained to a particular form of subject matter or scope or source. A narrative is an account of events, experiences and the like, whether non-fictional or fictional. A general narrative is a narrative that is not constrained to a particular form of subject matter or scope or source.

Structured data is information that has a clearly defined organization of its elemental parts, and is in contrast to unstructured data, which is information that does not have such a clearly defined organization of its elemental parts. A common form of unstructured data is information in the form of natural language, which is a language used by a group of speakers. Information expressed using natural language, whether spoken or written, does not have a clearly defined organization of its elemental parts because, at present, no complete theory of natural language exists to provide such defined organization. Information expressed using writing in natural language is referred to herein as natural language text.

It would be desirable to provide systems and methods that enable a human user to efficiently interact with general events and with general narratives as structured data. In some embodiments, interacting with a general event or a general narrative may comprise the system and/or the method of receiving information sufficient to create a new representation of a general event (a record of an event 320) or a new representation of a general narrative (a structured narrative 400). In some embodiments interacting with a general event or general narrative may comprise the system and/or the method of retrieving a previously created record of an event 320 or a previously created structured narrative 400. In some embodiments, interacting with the general event or general narrative may comprise the system and/or the method modifying the previously created record of an event 320 or the previously created structured narrative 400.

### Advantages

Some advantages of some embodiments described herein for enabling the user to interact with general events and general narratives as structured data include, but are not limited to: enabling representations of general events (records of events 320) and representations of general narratives (structured narratives 400) to be created directly as structured data and without the process step of first describing the general events and general narratives in natural language and then extracting structured data from that natural language, thereby enabling the capture of and interaction with general events and general narratives without primary use of spoken or written natural language; and enabling an approach to interacting with general events and general narratives that does not require a complete theory of natural language, and which is therefore simpler and more suited for practical use than systems and methods that require such a theory; and enabling the control of the elements of representations of general events (records of events 320) and representations of general narratives (structured narratives 400) by human editors such that the form and use of those representations can be controlled by the human editors for purposes of quality, standardization and the like.

Creating and consuming general events and general narratives as spoken and written natural language is natural to humans and is ubiquitous in human experience, but interacting with general events and general narratives as structured data, without dependence on spoken or written natural language, has no precedence in human history and is unknown in practice. Such a technique has only recently become feasible because of the availability of computers capable of managing extensively networked knowledge, and is only possible because of the extreme precision achievable with computers in precisely coordinating and integrating many references to many data records within many different data stores. Embodiments of the present invention demonstrate practical systems and methods for using a computer system to represent and interact with general events and general narratives as structured data, independent of spoken or written natural language, and that are suitable for wide application for ordinary human purposes.

### Overview of Key Elements

Embodiments of the present invention provide systems and methods for the storage of, retrieval of, and interaction with general events and general narratives by using structured data in the form of records of events 320 and structured narratives 400. Each structured narrative 400 comprises an ordered set of references to records of events 320 and each record of an event 320 comprises references to verb-concepts (verb concepts) 300 and to noun-concepts (noun concepts) 350 arranged according to a definition of a class of events 310 to which the represented general event belongs. These structured narratives 400 are therefore structured data that encapsulate the essence of the general narratives that they represent, and they are not common natural language narratives in which the general narratives are represented using written or spoken natural language.

### A Record of an Event

Each structured narrative 400 is stored in the structured narratives data store 205 and comprises an ordered set of references to records of events 320. Records of events 320 are considered here to be representations of general events in the real world, or in a fictional world, of any granularity of importance, for example “President Obama traveled to Chicago”, or “Councilman Smith spoke in support of council motion A456”, or “Councilman Smith took a sip of water”, or “Gandalf killed the dragon”. These general events occur frequently, in the real world or in fictional story worlds. They relate to specific activity concerning various specific things in the world (characters, entities, information and the like) and they are considered to occur in a particular location and during a particular interval in time. These general events are considered here to be discrete things each with its own unique and permanent identity. As representations of distinctly identifiable occurrences, records of events within the embodiment are assumed to have no special relationship with, or dependence on, written or spoken natural language. They are considered to originate from, and to independently exist in the real world, or in the fictional story world, and not within written or spoken natural language, although they can be and commonly are represented using written or spoken natural language. This approach to the nature of, and origin of, individual general events enables the definition of records of events and the useful application of unique identifiers to records of events.

### A Structured Narrative

Structured narratives 400 are considered here to be representations of general narratives, which are recountings of a series of general events that occur in the real world or in a fictional story world. Examples of general narratives are common in human experience, and include non-fictional general narratives such as “The Story of the Second World War”, and fictional general narratives such as “Little Red Riding Hood”. Representations of general narratives using written or spoken natural language are also common in human experience, and are the basis of articles, books, scripts and the like. These representations of general narratives, whether fictional or non-fictional and whether expressed in natural language or otherwise, are assembled by selecting and ordering representations of general events, and also by representing variations in the relative importance of different general events within the representation of the general narrative, and also by representing variations in the degree of event detail within the representation of the general narrative. This approach to the nature of general narratives and to the representation of general narratives enables the definition of structured narratives 400 using records of events 320 within embodiments.

Note on plural forms of terminology: In this description the term ‘records of events’ is the plural form of ‘record of an event’, and the term ‘definitions of classes of events’ is the plural form of ‘definition of a class of events’, and the term ‘definitions of classes of narratives’ is the plural form of ‘definition of a class of narratives’.

### Overview of Components

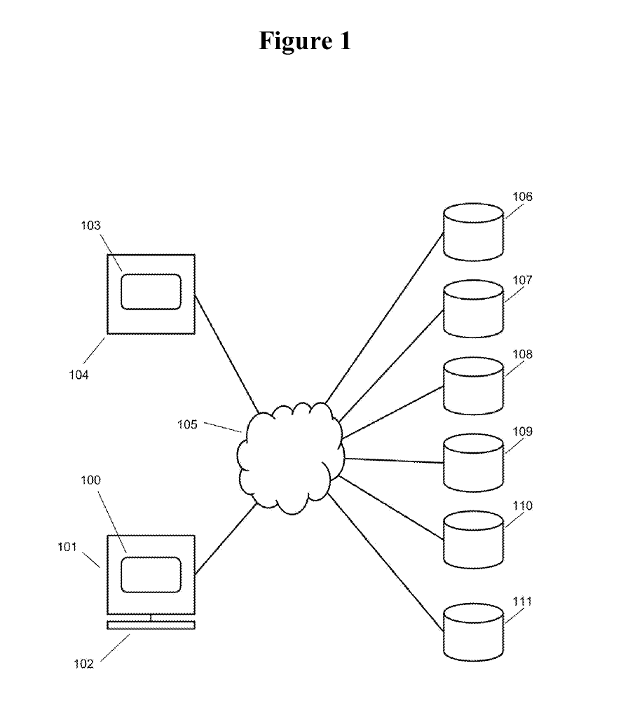

FIG. 1 is a simplified block diagram of the networked system, computer hardware and media used in an embodiment of the present invention. Several elements in the system shown in FIG. 1 include conventional, well-known elements.

### Graphical User Interface Computer Device Component

In some embodiments, for example, each graphical user interface 100 may operate on a computer device 101 that may include a desktop personal computer, workstation, laptop computer, wearable computer, tablet computer, mobile phone or any other computing device capable of interfacing directly or indirectly to a network 105. The graphical user interface 100 is typically operated in a browsing program, such as Apple's Safari Browser™, Microsoft's Internet Explorer™ browser, the Chrome™ browser, the FireFox™ browser, or in a browser or other application on a mobile phone, tablet computer or other wireless device, or the like, allowing a user of the graphical user interface 100 to access, view and interact with the information made available to it from the event and narrative server 103 over the network 105. The graphical user interface computer device 101 also typically includes one or more user input devices 102, such as a keyboard, a mouse, a touch screen or the like, used for interacting with the graphical user interface 100. The graphical user interface 100 may be transmitted and downloaded to a computing device from a software source such as an event and narrative server 103, any other remote server, or may also be provided on any software storage medium (CD, DVD, etc.) that is readable by the computing device 101 on which the graphical user interface 100 is operated. A graphical user interface 100 advantageously includes instructions for controlling the event and narrative server 103 and its components to communicate with data stores 200, 201, 202, 204, 205 and 206, and to process and display data content received therefrom. In some embodiments the graphical user interface 100 is configured to interact with the event and narrative server 103 via the Internet.

### Event and Narrative Server Computer Device Component

In some embodiments the event and narrative server 103 and all of its components operate on a computer device 104 that may comprise a server computer, a distributed computer, a mainframe computer or any other computer capable of interfacing directly or indirectly to the network 105. The event and narrative server 103 and all of its components are operator configurable using an application including executable code run using a processor such as an Intel Pentium™ processor, AMD Athlon™ processor, or the like, or on multiple processors.

### Computer-Readable Media Components

In some embodiments the definitional computer-readable media 108, the verb-concepts computer-readable media 106, the noun-concepts computer-readable media 107, the records computer-readable media 109, the narratives computer-readable media 110 and the narratives definitional computer-readable media 111 are ordinary non-transitory data storage media such a hard disk, solid state non-transitory memory, tape system, and the like. Each such computer-readable media is typically associated with a processor and a network card enabling access to the contents of the computer-readable media across a network 105. Each such computer-readable media is also typically equipped with a computer processor operating system and/or database software enabling the computer-readable media to be configured as and used as a data store.

### Network Component

Some embodiments of the present invention are suitable for use with the Internet, which refers to a specific global internetwork of networks. However, it should be understood that in some embodiments other networks can be used instead of, or in addition to, the Internet, such as an intranet, an extranet, a virtual private network (VPN), a non-TCP/IP based network, a local area network (LAN) or wide area network (WAN) or the like. It should also be understood that a network 105 that is entirely internal to a single computer device, with each element of the entire system residing on that same computer device, can also be used in some embodiments of the present invention.

### Executable Code Components

Executable code for implementing aspects of some embodiments of the present invention can be C, C++, HTML, Java, JavaScript, Ruby, Scala, Python, Swift, ObjectiveC code and the like, or any other suitable scripting language or programming language that can be executed on the event and narrative server computer device 104 or that can be compiled to execute on the event and narrative server computer device 104. Interface executable code can be any similar or suitable scripting language or programming language that can be executed on the graphical user interface computer device 101, or that can be compiled to execute on the graphical user interface computer device 101.

It will be appreciated by one skilled in the art that the system described herein is illustrative and that variations and modifications are possible. The definitional computer-readable media 108, the verb-concepts computer-readable media 106, the noun-concepts computer-readable media 107, the records computer-readable media 109, the narratives computer-readable media 110, the narratives definitional computer-readable media 111, and the event and narrative server 103 may be part of a single organization or they may be part of disparate organizations. Each such system includes at least one event and narrative server 103 and at least one associated set of computer-readable media 106, 107, 108, 109, 110 and 111, but may include multiple event and narrative servers 103 and multiple associated sets of computer-readable media 106, 107, 108, 109, 110 and 111 which may be geographically distributed.

### User Component

The system and methods of the present invention are operable by a user, which is a human being who operates the graphical user interface 100 and thereby interacts with the definitions of classes of events 310 in the definitional data store 201, the records of events 320 in the records data store 202, and the structured narratives 400 in the structured narratives data store 205.

### System Overview

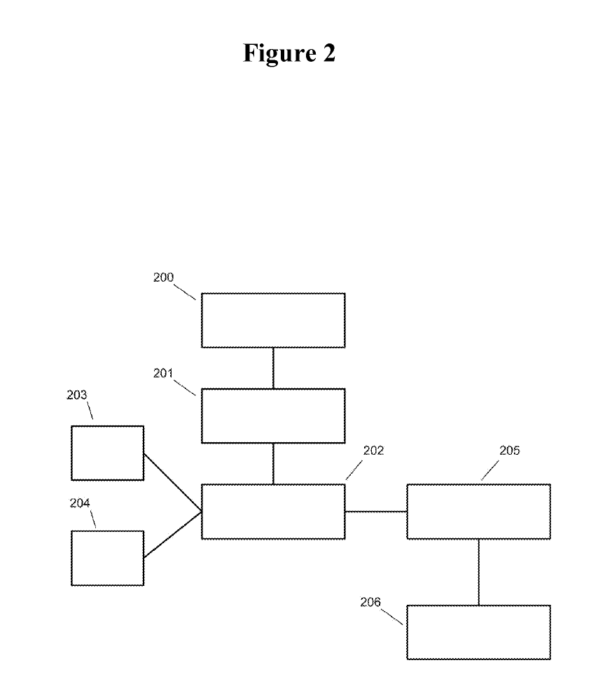

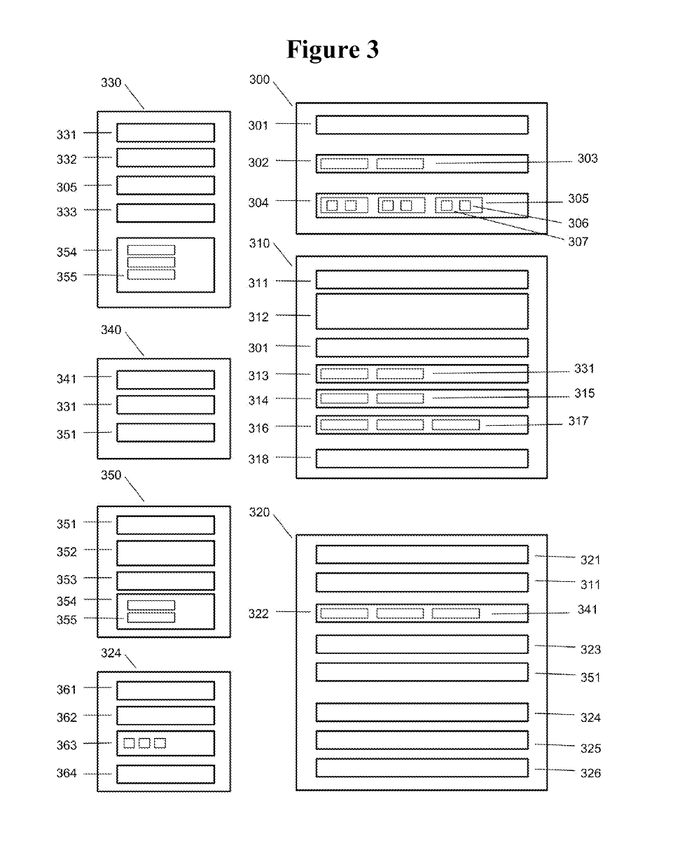

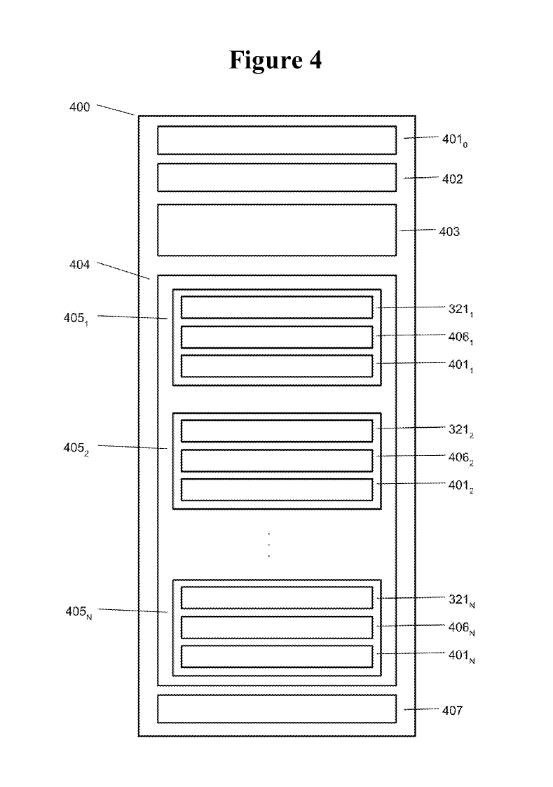

FIG. 2 is a simplified block diagram of the parts of an embodiment and their arrangement within the embodiment. FIG. 3 shows the parts that make up a record of an event 320, and FIG. 4 shows the parts that make up a structured narrative 400. At the highest level the embodiment first enables assembly of records of events 320 from verb-concepts (verb concepts) 300 and noun-concepts (noun concepts) 350, and then assembles structured narratives 400 from records of events 320. The assembly of a record of an event 320 requires information from the definitional data store 201, the verb-concept data store 200 and the noun-concept data store 203, and the assembled record of an event 320 is then stored in the records data store 202. The assembly of a structured narrative 400 requires the selection and ordering of references to two or more records of events 320, each of which are associated with a importance-value (importance value) 406 indicating their importance within the structured narrative 400 and with a reference to another structured narrative 400 that may provide more detail about the record of the event 320.

### Verb-Concept Data Store

The verb-concept data store 200 contains a plurality of verb-concepts 300, which may be organized into various categories.

A verb-concept 300 is a systematic description of the form of an activity and the roles that play a part in that activity. For example ‘speaking’ is the abstract form of an activity and ‘speaker’ and ‘listener’ are roles that play a part in that activity. This is in contrast to specific forms of the activity, such as ‘John spoke to Mary’, which refers to a specific speech act in which the ‘speaker’ role is specifically filled (occupied) by ‘John’ and the ‘listener’ role is specifically filled (occupied) by ‘Mary’.

More specifically a verb-concept 300 comprises the following elements: a set of one or more verbs of similar meaning 302 that express the verb-activity (verb activity) of the verb-concept 300, and a set of one or more verb-roles (verb roles) 304 that participate in that verb-activity, and a verb-concept-identifier (verb concept identifier) 301 that uniquely defines the verb-concept 300 within the verb-concept data store 200.

A verb 303 is a member of a class of words that typically express action, state or a relation between two things and that function as the main elements of predicates in natural language. Verbs of similar meaning 302 are verbs that can be used to express similar activity and that are therefore often used interchangeably, for example ‘speak’ and ‘talk’ are verbs of similar meaning.

The verb-activity is the common activity expressed by the set of one or more verbs of similar meaning 302, and is an activity that is shared in common by the activity expressed by each of the one or more verbs of similar meaning 302.

A verb-role 305 is a representation of a role that is involved in the verb-activity of the verb-concept 300. A verb-role 305 expresses a particular kind of thing that commonly exists within the context of the verb-activity, which is commonly referenced by the verb-activity and which is commonly referenced in natural language by the verbs of similar meaning 302 within the verb-concept 300. A verb-role 305 is a place-holder for a specific thing that makes sense to human beings when considered within the context of the verb-activity of the verb-concept 300 and which is a participant in that verb-activity. For example ‘speaker’ and ‘listener’ are verb-roles 305 that make sense within the verb-activity expressed by the verbs of similar meaning ‘speak’ and ‘talk’, and that participate in that verb-activity. Each verb-role 305 is uniquely identified within the verb-concept 300 by a verb-role-identifier (verb role identifier) and by a verb-role-name (verb role name) 307, which can be a text name.

In addition to verbs of similar meaning 302 and verb-roles 305, verb-concepts 300 may also contain other elements, such as a textual description of the verb-concept 300 or natural language text sentences providing examples of the verb-concept 300 or sets of words commonly associated with the verb-concept 300. Verb-concepts 300 may also contain multiple sets of verbs of similar meaning 302 in multiple natural languages, with all of the verbs of similar meaning 302 in each set being of one natural language.

In some embodiments of the present invention the verb-concept data store 200 may be one or more external verb-concept data stores such as FrameNet, VerbNet, PropBank and the like. In some embodiments of the present invention the verb-concept data store 200 may be comprised of multiple different verb-concept data stores that are accessed and used in similar ways.

### Noun-Concept Data Store

The noun-concept data store 203 contains a plurality of noun-concepts 350.

A noun-concept 350 is a uniquely defined record representing a specific thing of any kind, such as a person, an organization, an entity, a location, a document, a quote, a concept, a law, a physical object, a song, a number, an abstract idea, or any other thing that can be the object of thought.

More specifically a noun-concept 350 comprises the following elements: A noun-concept-identifier (noun concept identifier) 351 that uniquely defines the noun-concept 350 within the noun-concept data store 203, a noun-concept-description (noun concept description) 352 that comprises a description of the noun-concept 350 in natural language text and/or other means of description, and one or more noun-categories (noun categories) 354 which are categories that organize the noun-concept 350 relative to other noun-concepts within the noun-concept data store, one category of which is a primary noun-category 353. In some embodiments the noun-concept-description 352 can be a description in natural language text and/or a description using data that relates in a specific way to the noun-concept 350, such as a latitude/longitude coordinate of a location noun-concept, an age for a character noun-concept, a document length for an information noun-concept and similar data that relates in a specific way to the noun-concept 350.

In some embodiments of the present invention the noun-concept data store 203 may be comprised of multiple different noun-concept data stores that are accessed and used in similar ways, for example a location noun-concepts data store 204 that contains only location noun-concepts, or a noun-concept data store 203 that contains only noun-concepts 350 that are people or organizations. In some embodiments the noun-concept data store 203 may be one or more external noun-concept data store such as Freebase, Yago™, Google™ Knowledge Graph, WikiData, Bing™ Satori, Facebook™, LinkedIn™, IMDb™, Musicbrainz™, Geonames, Factual™ World Geographies Data, and the like.

### Definitional Data Store

The definitional data store 201 contains a plurality of definitions of classes of events 310.

A definition of a class of events 310 is a uniquely defined record representing a class of events, for example the class of events in which one person speaks to another person, or the class of events in which an organization hires a person. Classes of events are in contrast to specific events such as ‘John spoke to Mary on Tuesday in Atlanta’ or ‘Acme Corporation hired John in 2009 in Canada’. A definition of a class of events 310 also provides sufficient information to make a record of an event 320 that is a member of the class of events that is represented by the definition of a class of events 310. Each definition of a class of events 310 is related to a single verb-concept 300, identified within the definition of a class of events 310, and may be considered as a special case of that verb-concept 300 in which the verb-activity and verb-roles 304 are constrained in important ways. The constrained verb-activity is termed ‘event-activity’ (event activity) and the constrained verb-roles are termed ‘event-roles’ (event roles) 330.

More specifically in some embodiments a definition of a class of events comprises the following elements: An event-class-identifier (event class identifier) 311 that uniquely describes the definition of a class of events 310, an event-class-description (event class description) 312 that describes the class of events that is defined by the definition of a class of events 310 in text, a verb-concept-identifier 301 that identifies a verb-concept 300 within the verb-concept data store 200, one or more ordered event-roles 313 that describe the participants in the event-activity of the class of events that is defined by the definition of a class of events 310, one or more ordered natural language text phases 314 that together with the event-roles 313 describe the event-activity and one or more class-categories 316 that organize the definition of a class of events 310 within the definitional data store 201.

Each event-role 330 within a definition of a class of events 310 is a placeholder for a specific noun-concept 350 that will be selected when a record of an event 320 is created using the definition of a class of events 310. Within a definition of a class of events 310 each event-role 330 is related to a particular verb-role 305 within the verb-concept 300 identified by the verb-concept-identifier 301, and the event-activity is expressed within the one or more natural language text phrases 314, one of which includes one of the one-or-more verbs of similar meaning 302 from that verb-concept 300 and is thereby related to the verb-activity of the verb-concept 300.

More specifically each of the event-roles 313, 330 within a definition of a class of events 310 comprises the following elements: a position of the role within the order (for example first, second, third, etc.), an event-role-name (event role name) 332 that uniquely names the event-role within the definition of a class of events 310, an event-role-identifier (event role identifier) 331 that uniquely identifies the event-role 330 within the definition of a class of events 310, a verb-role-identifier 306 that identifies a specific verb-role 305 within the verb-concept 300 identified by the verb-concept-identifier 301 contained in the definition of a class of events 310, one permitted-category (permitted category) for the event-role 330 and one or more permitted-sub-categories (permitted sub categories) for the event-role 330.

The permitted-category of the event-role 330 is one of a set of primary noun-categories 353 that organize noun-concepts 350 and that are the top level of organization of noun-concepts 350 within the embodiment. This set of primary noun-categories 353 comprises:

Character noun-concepts, which include any noun-concept 350 that can be construed as an intentional agent in any way, such as a person, an organization, a government, an animal, an intelligent machine and the like.

Entity noun-concepts, which include any noun-concept 350 that can be construed as a thing or concept, in particular noun-concepts 350 that are not categorized by other primary noun-categories 353 in the set.

Location noun-concepts, which include any noun-concept 350 that can be construed as a geographic location or as a geographic coordinate or as a spatial region of any kind, such as a building, a neighborhood, a city, a state, a region, a country, a continent, a planet and the like.

Information artifact noun-concepts, which include any noun-concept 350 that can be construed as information, such as a document, a quotation, a web page or web link, a law, and the like.

Reference event noun-concepts, which include any reference to a record of an event 320 within the records data store 202 of an embodiment.

Reference narrative noun-concepts, which include any reference to a structured narrative 400 within the structured narratives data store 205 of an embodiment. Constant noun-concepts, which include any value or number that is invariant and fixed for all time, such as an integer or real number, a year, a particular quantity and the like.

The permitted-sub-categories of the event-role 330 within a definition of a class of events 310 are selections from the one or more noun-categories 354 used to organize noun-concepts 350 within the noun-concept data store 203.

In some embodiments a primary location event-role, which is an event-role 330 with the permitted-category of location noun-concept, is one of the one or more event-roles 313 in all definitions of classes of events 310. The primary location event-role is a placeholder for a location noun-concept that represents the particular location in which the general event is considered to have occurred (the primary location).

Each of the ordered natural language text phrases 315 within a definition of a class of events 310 comprises one or more words, one said word in one said natural language text phrase being a verb selected from the one or more verbs of similar meaning 302 within the verb-concept 300 identified by the verb-concept-identifier 301 contained in the definition of a class of events 310. In some embodiments the order of the natural language text phrases 314 is such that the ordered natural language text phrases 314 are interspersed with the ordered event-roles 313 to form a unique combination of natural language text phrases 314 and event-roles 313 that conveys the event-activity of the definition of a class of events 310. In some such embodiments the ordering of the unique combination of natural language text phrases 314 and event-roles 313 is such that an event-role 330 is in the first position of the order. An example of such a unique combination of natural language text phrases 314 and event-roles 313 in such an embodiments is “[John Smith] spoke in support of [public schools]”, in which the noun-concept-descriptions 352 referenced from the event-roles 313 are enclosed in square brackets, and the remainder of the description comprises a natural language text phrase 315.

In some embodiments one or more definitional-media-element (definitional media element) 318 is associated with some definitions of classes of events 310. Each definitional-media-element 318 within a definition of a class of events 310 is either directly contained within the definition of a class of events 310 or is associated by reference, and comprises one or more discrete units of media that describes in some way the class of events that is represented by the definition of a class of events 310. Examples of these discrete units of media are a short natural language text sentence, such as a bullet point, a longer natural language text summary, an image, a video recording, an audio recording, a document, a web link and any other method of description of the class of events within a medium.

### Records Data Store

The records data store 202 contains a plurality of records of events 320.

A record of an event 320 is a uniquely defined record representing a single specific general event. A specific general event is an actual event that actually happened among actual characters, entities, information, locations and the like, within the real world or within a fictional story world, and which is considered to be a discrete and identifiable thing. A record of an event 320 is a representation of that specific general event that is made by choosing a definition of a class of events 310 that represents a class of general events in which the specific general event is a member, and then choosing specific noun-concepts 350 to occupy each of the event-roles 313, 330 of the definition of a class of events 310 as noun-participants (noun participants) 340, a specific primary location noun-concept and a specific time reference 323 and temporal duration that together define the record of an event 320.

More specifically, in some embodiments, a record of an event 320 comprises the following elements: an event-record-identifier (event record identifier) 321 which uniquely identifies the record of an event 320 within the records data store 202, an event-class-identifier 311 which uniquely identifies the particular definition of a class of events 310 within the definitional data store 201 that defines the record of an event 320, one noun-participants 340 for each event-role 313, 330 within the definition of a class of events 310 identified by the event-class-identifier 311, a time reference 323 and temporal duration, and a primary location noun-concept identifier 351. In such embodiments the primary location noun-concept occupies the primary location event-role and represents the primary location associated with the event.

Within the record of an event 320 each noun-participant 340 identifies a particular noun-concept 350 that is to be associated with a particular event-role 330 within the definition of a class of events 310 identified by the event-class-identifier 311. Each noun-participant 340 comprises: a noun-participant-name (noun participant name) 341 that names the noun-concept 350 within the record of an event 320 and which may be identical to part of the noun-concept-description 352 of the noun-concept 350; an event-role-identifier 331 that uniquely identifies an event-role 330 within the definition of a class of events 310 identified by the event-class-identifier 311; and noun-concept-identifier 351 that uniquely defines a noun-concept 350 within the noun-concept data store 203. The noun-concept 350 identified by the noun-concept-identifier 351 of a noun-participant 340 must be of the permitted-category and of any permitted-sub-categories associated with the event-role 330 within the definition of a class of events 310 identified by the event-class-identifier 311.

A record of an event 320 may also comprise the following additional elements: one or more event-relationships (event relationships) 324 which identify a relationship between the record of an event 320 and another record of an event 320 within the records data store 202; one or more event-media-elements (event media elements) 325 which are descriptions in various kinds of media that describe the general event represented by the record of an event 320, and one or more event-media-references (event media references) 326 which are associations between the record of the event 320 and various documents, articles, videos and the like that are related to the general event represented by the record of an event 320, for example source documents or explanatory natural language text articles.

Each event-relationship 324 within a record of an event 320 comprises: a second-event-record-identifier (second event record identifier) 361 that uniquely identifies a second record of an event 320 within the records data store 202 that is related to the record of an event 320 that contains the event-relationship; a directional-indicator (directional indicator) 362 that indicates the direction of the relationship, including the cases of first record to second record, second record to first record and a bi-directional relationship between the second record and first record; one or more relational-categories (relational categories) 363, which are categories that organize the event-relationship; and a relational-description (relational description) 364, which is a textual description of the event-relationship 324. In some embodiments an event-relationship 324 between two records of events 320 is a cause and effect relationship, in which the directional-indicator 362 indicates which record of an event 320 is the cause and which record of an event 320 is the effect, and for which the nature of the cause and effect relationship can be categorized using one or more relational-categories 363 and described using a relational-description 364. In some embodiments event-relationships 324 between two records of events 320 may be temporal, spatial, topic hierarchical or parent-child relationships. In some embodiments the event-relationship 324 may be stored independently of the record of an event 320, in which case the event-relationship 324 would contain an additional event-record-identifier 321 that uniquely identified an additional record of an event 320 within the records data store 202.

In some embodiments each event-media-element 325 within a record of an event 320 is an attachment to the record of the event 320, either directly within the record of an event 320 or by reference, of one or more discrete units of media that describes in some way the general event that is represented by the record of an event 320. Some examples of these discrete units of media are a short natural language sentence, such as a bullet point, a longer natural language summary, an image, a video recording, an audio recording, a document, a web link and any other method of description of the general event within a medium.

In some embodiments each event-media-reference 326 within a record of an event 320 is an attachment to the record of the event 320, either directly within the record of an event 320 or by reference, of one or more discrete units of media that are related in some way to the general event that is represented by the record of an event 320. Some examples of these discrete units of media include text articles that refer to the general event, documents that are the source materials for the general event, web links, video files and audio files that are related to the general event, and units of media that use other methods of description within a medium and that are related to the general event.

### Structured Narratives Data Store

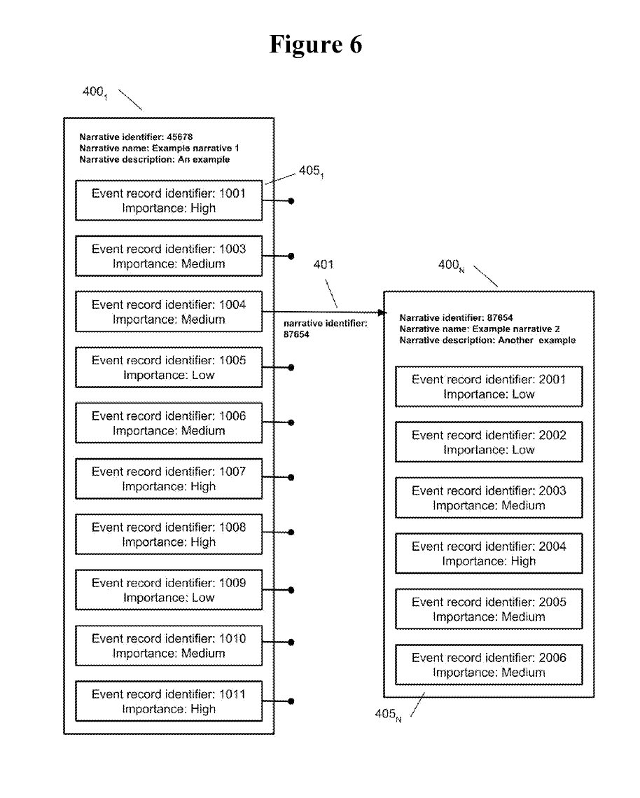

The structured narratives data store 205 contains a plurality of structured narratives 400. FIG. 4 shows the parts that make up a structured narrative 400 and FIG. 6 shows an example of a structured narrative 400.

A structured narrative 400 is a uniquely defined record representing a specific general narrative. A specific general narrative is a series of general events that are arranged in a certain order, often a temporal order, and that each have a particular importance within the general narrative, and which may also each be usefully associated with additional general narratives that provide additional detail about the general event as a series of more detailed general events.

More specifically in some embodiments a structured narrative 400 comprises the following elements: A narrative-identifier (narrative identifier) 401, which uniquely identifies the structured narrative within the structured narratives data store 205; a narrative-name (narrative name) 402, which is a short textual label that names the structured narrative; a narrative-description (narrative description) 403, which is a longer textual description that further describes and summarizes the structured narrative 400 in natural language text; and an ordered plurality of event-references (event references) 404 that contain the substance of the structured narrative 400. A structured narrative 400 may also comprise one or more narrative-media-elements (narrative media elements) 407 which are associations between the structured narrative 400 and various documents, articles, videos and the like that are related to the general narrative represented by the structured narrative 400, for example source documents or explanatory natural language text articles.

The event-references 405 within the ordered plurality of event-references 404, individually and together, organize a plurality of records of events into a single narrative unit. Each event-reference 405 comprises the following elements: an event-record-identifier 321 that uniquely identifies a record of an event 320 within the records data store 202; an importance-value (importance value) 406 that is a selection from a common scale that indicates the importance of the event-reference 405 relative to other event-references within the narrative, for example a importance-value of 2 on a common scale that ranges from 1 to 5; a narrative-identifier 401 that uniquely identifies another structured narrative 400 within the structured narratives data store 205, which is a detail-narrative (detail narrative) relating to the record of an event 320 identified by the event-record-identifier 321 in the event-reference 405. A detail-narrative expands a particular record of an event 320 into a full structured narrative 400 by being associated with a narrative-identifier 401 for that structured narrative 400 within an event-reference 405, and can be any structured narrative 400 stored within the structured narratives data store 205. An example of a structured narrative 400 containing an event-reference 405 with a narrative-identifier 401 for a detail-narrative is shown in FIG. 6.

In some embodiments each narrative-media-element 407 within a structured narrative 400 is an attachment to the structured narrative 400, either directly within the structured narrative 400 or by reference, of one or more discrete units of media that describes in some way the general narrative that is represented by the structured narrative 400. Examples of these discrete units of media are a short natural language sentence, such as a bullet point, a longer natural language summary, an image, a video recording, an audio recording, a document, a web link, and units of media using other methods of description within a medium of the general narrative.

### Narratives Definitional Data Store

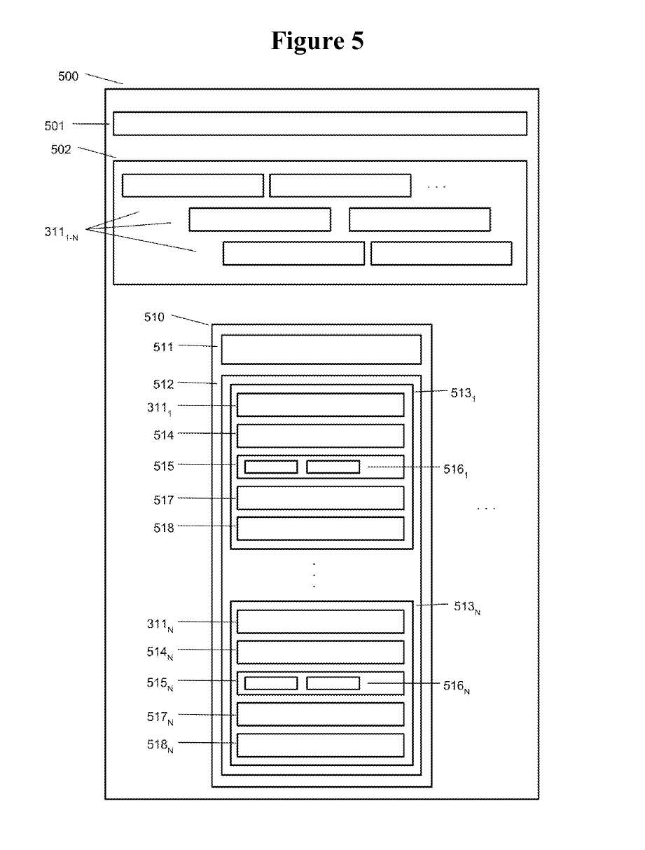

The narratives definitional data store 206 contains a plurality of definitions of classes of narratives 500. FIG. 5 shows the parts that make up a definition of a class of narratives 500.

In some embodiments a definition of a class of narratives 500 is a uniquely defined record representing a class of narratives, for example the class of narratives in which a person makes a journey, or the class of narratives in which a person's life is described, or the class of narrative in which a person faces and then overcomes a challenge. Definitions of classes of narratives 500 are in contrast to the specific structured narratives 400 stored in the structured narratives data store 205, and each class of narratives 500 may describe many different specific structured narratives 400.

In some embodiments classes of narratives described by definitions of classes of narratives 500 do not define structured narratives 400 in the way in which definitions of classes of events 310 define records of events 320, and therefore structured narratives 400 can be defined, constructed and used without any use of, or reference to, a definition of a class of narratives 500.

Each definition of a class of narratives 500 is an unordered plurality of definitions of classes of events 502 combined with one or more ordered event-class-arrangements (event class arrangements) 510, which are arrangements in different orders of some or all of the unordered plurality of definitions of classes of events 502. These event-class-arrangements 510 are different possible forms of the class of narratives described by the definition of a class of narratives 500, and each event-class-arrangement 510 is associated with a set of percentage values for different elements that indicate the degree, expressible as a real number probability between 0 and 100, to which each element is required to be present in order to represent the class of narrative described by the definition of a class of narratives 500.

More specifically in some embodiments a definition of a class of narrative 500 comprises the following elements: a narrative-class-identifier (narrative class identifier) 501 that uniquely identifies the definition of a class of narratives 500 within the narrative definitional data store 206, an unordered plurality of event-class-identifiers 502 each of which uniquely identifies a definition of a class of events 310 within the definitional data store 201, and one or more event-class-arrangements 510, each of which comprises an ordered list of some or all of the unordered plurality of event-class-identifiers 502.

More specifically each event-class-arrangement 510 comprises:
An ordered list of one or more references to event-class-identifiers 512, each event-class-identifier 311 being selected from within the unordered plurality of event-class-identifiers 502, such that said ordered list represents a valid arrangement of the class of narratives described by the definition of a class of narratives 500;
One narrative-percentage-value (narrative percentage value) 511 that indicated the degree, expressible as a real number probability between 0 and 100, to which the event-class-arrangement 510 represents the class of narratives described by the definition of a class of narratives 500;
An event-class-percentage-value (event class percentage value) 514 for each event-class-identifier 311 in the event-class-arrangement 510, indicating the degree, expressible as a real number probability between 0 and 100, to which a record of an event 320 defined by the definition of a class of events 310 identified by the event-class-identifier 311 is required to be present within the event-class-arrangement 510 in order to represent the class of narratives described by the definition of a class of narratives 500;
One or more noun-concept-percentage-values (noun concept percentage values) 515 for each event-role 330 within the definition of a class of events 310 identified by each event-class-identifier 311 within the event-class-arrangement 510, and each noun-concept-percentage-value 516 being associated with a noun-concept 350 or noun-category 355 such that it indicated the degree, expressible as a real number probability between 0 and 100, to which that noun-concept 350 or noun-category 355 is required to be present within event-role 330 within the referenced definition of a class of events 310 within the event-class-arrangement 510 in order to represent the class of narratives described by the definition of a class of narratives 500;
One or more primary-location-percentage-values (primary location percentage values) 517 for each event-class-identifier 311 in the event-class-arrangement 510, each primary-location-percentage-value 517 representing the degree, expressible as a real number probability between 0 and 100, to which a location noun-concept or a location noun-category is required to be present within records of events 320 defined by that definition of a class of events 310 within the event-class-arrangement 510 in order to represent the class of narratives described by the definition of a class of narratives 500.
One or more time-reference-percentage-values (time reference percentage value) 518 for each event-class-identifier 311 in the event-class-arrangement 510, each time-reference-percentage-value 518 representing the degree, expressible as a real number probability between 0 and 100, to which a time reference 323 or a sequence of time references is required to be present within records of events 320 defined by that definition of a class of events 310 within the event-class-arrangement 510 in order to represent the class of narratives described by the definition of a class of narratives 500. A sequence of time references may be in the form of temporal offsets from other time references, such as the time references in preceding or following records of events 320.

In some embodiments the executable code within the event and narrative server 103 may instruct the processor to identify various arrangements of records of events (narrative patterns) within a structured narrative 400 that match predetermined patterns. These narrative patterns, and the predetermined patterns that they match, comprise:
Class arrangements, based on arrangements of the use of particular definitions of classes of events 310 within records of events within the order of event-references 405 within the structured narrative 400.
Role arrangements, based on arrangements of records of events 320 that contain event-roles 330 that are occupied by certain noun-concepts 350 and/or by certain categories of noun-concepts 354 within the order of event-references 405 within the structured narrative 400.
Location noun-concept arrangements, based on records of events 320 that contain particular location noun-concepts, categories of location noun-concepts or geographic arrangements of location noun-concepts (such as proximity and the like) within the order of event-references 405 within the structured narrative 400.
Temporal arrangements, based on records of events 320 that contain particular sequences of time references 323, such as sequences defined by distance in time, periodicity and the like, within the order of event-references 405 within the structured narrative 400.

In some embodiments the identification of these arrangements of records of events 320 (narrative patterns) by comparison with predetermined patterns may be used to generate new definitions of classes of narratives 500, for example by identifying a match between a particular arrangement of records of events 320 within a structured narrative 400 and a predetermined pattern that is not similar to existing definitions of classes of narratives 500.

In some embodiments new definitions of classes of narratives 500 generated by comparison with predetermined narrative patterns may be used to automatically, within the at least one event and narrative server 103, create new structured narratives 400 by selecting existing records of events 320 from the records data store 202 based on the definitions of classes of events 310 and other elements used within the records of events 320.

In some embodiments the event-class-percentage-values 514, the noun-concept-percentage-values 515, the primary-location-percentage-values 517 and the time-reference-percentage-values 518 associated with a definition of a class of narratives 500 may be compared with an existing structured narrative 400 within the structured narratives data store 205 and used to calculate, using simple multiplication of probabilities as apparent to one skilled in the art, a percentage probability, expressible as a number between 0 and 100, that an unspecified record of an event 320 of a particular definition of a class of events 310, with event-roles 330 occupied by particular noun-concepts 350 or the one or more categories of noun-concepts 354, with a particular location noun-concept or category of location noun-concept occupying the primary location event-role, or with a particular or approximate time reference 323 will be inserted into the existing structured narrative 400.

### Event and Narrative Server

Each of the at least one event and narrative servers 103, individually and/or together, enables the creation of, management of and interaction with records in the definitional data store 201, the verb-concept data store 200, the noun-concept data store 203, the records data store 202, the structured narratives data store 205 and the narratives definitional data store 206. These tasks are too complex for unaided human beings to complete, other than as isolated simple examples, because of the use of abstraction, and because of the extensive use of references between records in the data stores, and because of the need to enforce constraints such as the constraints of noun-concepts 350 to a permitted-category of primary noun-category 353 and permitted-sub-categories of noun-categories 354 when creating a record of an event 320. The use of at least one event and narrative server 103 to manage these tasks is therefore essential to the embodiments and their operation.

Each event and narrative server 103 is a computer device 104 that comprises, among other things, a processor and executable code in a scripting or programming or compiled language that runs on the processor, or on multiple processors, and that instructs the processor or processors to perform certain acts that cause the creation of, management of and interaction with records in the definitional data store 201, the verb-concept data store 200, the noun-concept data store 203, the records data store 202, the structured narratives data store 205 and the narratives definitional data store 206.

### Graphical User Interface

In some embodiments each of the at least one graphical user interface 100 is the means by which human users interact with the at least one event and narrative server 103, and therefore interact with the records in the definitional data store 201, the verb-concept data store 200, the noun-concept data store 203, the records data store 202, the structured narratives data store 205 and the narratives definitional data store 206.

Each graphical user interface 100 operates on a computer device 101 that comprises, among other things, a processor and interface executable code in a scripting language or programming language or compiled language that runs on the processor and that instructs the processor or processors to display the graphical user interface 100, to receive commands from the user via an input device 102 and to display information to the user via a display. In some embodiments the display of information from the embodiment on the graphical user interface 100 may use representations of text, two dimensional graphics, three dimensional graphics, graphics that are spatially registered to the body of the user, video, audio and the like.

### User System

In some embodiments users of the graphical user interface 100, who interact with records of events 320 and structured narratives 400, are uniquely identified. The unique identification of users is achieved by using a user access system that operates by requiring each user to establish a specific account within, or associated with, the embodiment, and by requiring a user to enter a text username and a text password known only to the user, or other unique identification information, in order to gain access to the embodiment and to interact with the embodiment. Upon gaining access to the embodiment the user is then uniquely identified using a unique user identifier that is stored temporarily on the graphical user interface computer device 102, or on the event and narrative server computer device 104. As those of skill in the art will understand, a suitable user access system can be constructed using common practices, including using the Facebook user access system.

### Operation

### Operation—Creating Definitions of Classes of Events

In some embodiments, some or each of the plurality of definitions of classes of events 310 stored in the definitional data store 201 can be created by users using the at least one graphical user interface 100. The creation of a new definition of a class of event 310 requires sending to the at least one event and narrative server 103, a new definition of a class of events request and new definition of a class of events information. The new definition of a class of events request is an instruction to create a new definition of a class of events 310.

The new definition of a class of events information is direct or indirect information that is sufficient to create a new definition of a class of events 310. In some embodiments said information comprises a verb-concept-identifier 301, a set of ordered event-roles 313 each associated with a verb-role-identifier 306 that uniquely identifies a verb-role 305 within the verb-concept 300 identified by the verb-concept-identifier 301, and each associated with a permitted-category and permitted-sub-categories of noun-concepts 355 that can occupy the event-roles 330, 313. Said information also comprises a set of ordered natural language text phrases 314 that together and with the event-roles 313 describe the event-activity of the definition of a class of events 310 wherein each natural language text phrase 315 follows an event-role 330 and one natural language text phrase 315 also comprises a single verb from the one or more verbs of similar meaning 302 within the verb-concept 300 identified by the verb-concept identifier 301, and one or more noun-categories 354.

### Operation—Creating Records of Events

In some embodiments some of, or each of, the plurality of records of events 320 stored in the records data store 202 can be created by users using the at least one graphical user interface 100 in communication with the at least one event and narrative server 103. The creation of a new record of an event 320 requires sending to the at least one event and narrative server 103, a new event request and new event information. The new event request is an instruction to create a new record of an event 320.

The new event information is direct or indirect information that is sufficient to create a new record of an event 320, and in some embodiments comprises: an event-class-identifier 311 that identifies the particular definition of a class of events 310 within the definitional data store 201 that is to be used to define the record of an event 320; one or more noun-participants 340, each comprising a noun-participant name 341, an event-role-identifier 331 from within the particular definition of a class of events 310 chosen to define the record of an event 320, and a noun-concept-identifier 351 that identifies a noun-concept 350 in the noun-concepts data store 203 and that is associated with, and is therefore a member of, the correct permitted-category of noun-category 353 and permitted-sub-categories of noun-categories 354 for that event role 330; a time-reference 323, units of the time reference and temporal duration for the time reference; and a location noun-concept identifying the primary location of the record of an event 320 to be created. In some embodiments an event-record-identifier 321 that uniquely identifies the new record of an event 320 within the records data store 202 can also be part of the new event information, or alternatively may be generated automatically within the at least one event and narrative server 103 as part of the process of creating a new record of an event 320.

In some embodiments additional information defining one or more event-relationship 324 can be included with the new event information and become part of the new record of an event 320. In some embodiments this event-relationship information may be provided at a time later than the creation of the new record of an event 320 and associated with the record of an event 320 at that time.

In some embodiments additional information defining one or more event-media-elements 325 can be included with the new event information and become part of the new record of an event 320. In some embodiments this event-media-element information may be provided at a time later than the creation of the new record of an event 320 and associated with the record of an event 320 at that time.

In some embodiments the creation of a record of an event with an associated event-media-element 325 that is in natural language text, such as a bullet point or a summary written in a natural language such as English, can include the additional step of translating the associated natural language text event-media-element 325 into other natural languages, such as Spanish, French and the like, such that the event-media-element 325 is available in multiple different natural languages. This translation can be done using automated translation or human translation. This technique enables a structured narrative 400 to be translated by translating each of the individual event-media-elements 325 of individual records of events 320 in isolation.

In some embodiments additional information defining one or more event-media-references 326 can be included with the new event information and become part of the new record of an event 320. In some embodiments this event-media-references information may be provided at a time later than the creation of the new record of an event 320 and associated with the record of an event 320 at that time.

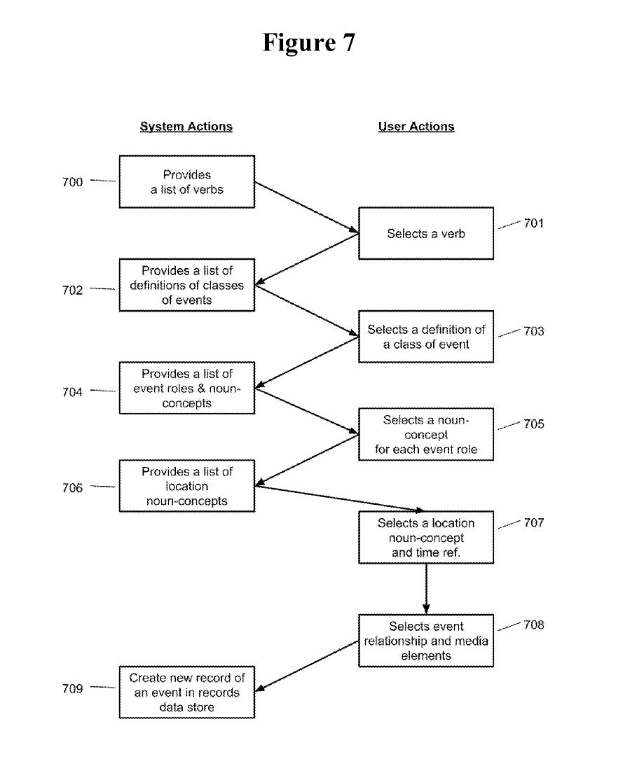

In some embodiments the creation a record of an event 320 can be accomplished solely through selecting from lists, thereby enabling the representation of a general event without writing in natural language, and thereby enabling the representation of a general narrative without writing in natural language. This selection technique is illustrated by FIG. 7 and begins with the user selecting 701 a verb 303 from a list of all verbs associated with available verb-concepts 300 within the embodiment and provided 700 to the user by the embodiment. The selected verb is then used to provide 702 a list of all definitions of classes of events 310 that utilize that verb, from which the user selects 703 a particular definition of a class of events 310. The embodiment then provides 704 a list of all event-roles 330 within that definition of a class of events 310, and of noun-concepts 350 that are associated with the permitted-category and permitted-sub-categories of those event-roles 330, from which the user selects 705 a particular noun-concept 350 for each event-role 330. The embodiment also provides 706 a list of location noun-concepts from which the user selects 707 a location noun-concept for the primary location event-role. The user also selects 707 a time reference 323 from a calendar or other display of points in time and also selects 708 any event-relationships 324 and any event-media-elements 325. This combined information is then used to create 709 the new record of an event 320 in the records data store 202.

In some embodiments records of events 320 can be created automatically, based on predetermined information being selected based on triggers using rules executed in the executable code within the at least one event and narrative server 103. These triggers can be changes in an external data store, or can be signals from a source of signals, or can be any predetermined trigger, and the predetermined information that is selected on the basis of those triggers comprises predetermined definitions of classes of events 310 and predetermined noun-concepts 350 that are associated with event-roles 313 within the predetermined definitions of classes of events 310.

### Operation—Creating and Updating Structured Narratives

In some embodiments some or each of the plurality of structured narratives 400 stored in the structured narratives data store 205 can be created by users using the at least one graphical user interface 100. The creation of a new structured narrative 400 requires sending to the at least one event and narrative server 103, a new narrative request and new narrative information. The new narrative request is an instruction to create a new structured narrative 400.

The new narrative information is direct or indirect information that is sufficient to create a new structured narrative 400, and in some embodiments comprises: a narrative-name 402 which names the structured narrative with a natural language text name; and a narrative-description 403 which provides a short natural language text description of the structured narrative 400 summarizing its contents; and an ordered plurality of event-references 404 that provide information about the records of events 320 that make up the structured narrative 400, wherein each event-reference 405 comprises: an event-record-identifier 321 identifying a particular record of an event 320 within the records data store 202; and an importance-value 406, on some scale such as 1 to 5, that represents the importance of the event-reference 405 relative to other event-references in the structured narrative 400; and a narrative-identifier 401 that identifies a detail-narrative, which is an existing structured narrative 400 within the structured narratives data store 205 that represents further, more detailed, general events that are summarized by the record of an event 320. In some embodiments a narrative-identifier 401 that uniquely identifies the new structured narrative 400 to be created within the structured narratives data store 205 can also be part of the new narrative information, or alternatively may be generated automatically within the at least one event and narrative server 103 as part of the process of creating a new structured narrative 400.

In some embodiments additional information defining one or more narrative-media-elements 407 can be included with the new narrative information and become part of the new structured narrative 400. In some embodiments this narrative-media-element 407 information may be provided at a time later than the creation of the new structured narrative 400 and associated with the structured narrative 400 at that time.

In some embodiments each of the plurality of structured narratives 400 stored in the structured narratives data store 205 can be modified by users using the at least one graphical user interface 100, including modified so as to include an additional event-reference 405 that identifies a record of an event 320 and that is inserted into the existing structured narrative 400 at any position in the order of event-references 404 within the structured narrative 400. The modification of an existing structured narrative 400 by insertion of a new event-reference 405 requires sending to the at least one event and narrative server 103, an event insertion request, event insertion information, a narrative-identifier 401 and an event-record-identifier 321. The event insertion request is an instruction to insert the record of an event 320 identified by the event-record identifier 321 into the structured narrative 400 identified by the narrative-identifier 401.

The event insertion information is direct or indirect information that is sufficient to insert an event-reference 405 into an existing structured narrative 400, and in some embodiments comprises: a position in the ordered plurality of event-references 404 at which to insert the new event-reference 405, either as an absolute position or a position relative to another event-references 404; and an importance-value 406 indicating the relative importance of the inserted event-reference 405 relative to other event-references 405 within the structured narrative 400 into which it is inserted; and a narrative-identifier 401 identifying a structured narrative 400 within the structured narratives data store 205 that is a detail-narrative for the record of an event 320 referenced by the event-reference 405.

In some embodiments other forms of modification by a user of a specified structured narrative 400 are possible, including modifying or replacing the narrative-name 402 of a specified structured narrative 400, modifying or replacing the narrative-description 403 of a specified structured narrative 400, deleting an event-reference 405 from a specified structured narrative 400, and moving an event-reference 405 from one position in the ordered plurality of event-references 404 within a specified structured narrative 400 to another position within the ordered plurality of event-references 404 of the same specified structured narrative 400. In some embodiments the modification records of events 320 are possible, including changing the noun-concept 350 associated with a specified event-role 330 within the record of an event 320, changing the location noun-concept associated with the primary location event-role within a record of an event 320, and changing the time reference 323 and/or the units and duration for the time reference 323 of a record of an event 320. The method of implementing these forms of modification of a specified structured narrative 400, by configuring the executable code within the at least one event and narrative server 103 and the interface executable code within the at least one graphical user interface 100 will be apparent to one skilled in the art.

Operation—User Interaction with Events and Narratives

In some embodiments each of the plurality of structured narratives 400 stored in the structured narratives data store 205, and each of the plurality of records of events 320 stored in the records store 202, can be retrieved by users using the at least one graphical user interface 100, including retrieved in ways so as to assemble displays of structured narratives 400 and of arrangements of structured narratives 400, and displays of records of events 320 and of arrangements of records of events 320 using the at least one graphical user interface 100.

The retrieval of an existing record of an event 320 from the records data store 202 requires sending to the at least one event and narrative server 103, a request for a complete or a partial record of an event 320, which comprises a event-record-identifier 321 that specifies the record of an event 320 to be retrieved and information indicating whether a complete or partial record is requested, and, if a partial record is requested, then information indicating what portion of the record of an event 320 is requested. Examples of such a request in some embodiments are a request for the event-media-elements 325 associated with the specified record of an event 320 or a request for the noun-concepts 350 associated with the specified record of an event 320. Upon receiving a request for a complete or a partial record of an event 320 the at least one event and narrative server 103 retrieves the requested record of an event 320 from the records data store 202 and communicates it to the graphical user interface 100 as requested.

In some embodiments a request for a complete or a partial record of an event may include an indication of a preferred language, indicating a natural language such as Spanish that is preferred by the user. Upon receiving such an indication of a preferred language the executable code in the embodiment will cause the retrieval of any event-media-elements 325 to be returned to the user in response to the request to be selected from those event-media-element 325 in the preferred language, for example text bullet points or text summaries in Spanish, such that the record of event 320 or a structured narrative 400 containing records of events 320 can be displayed in the preferred language.

The retrieval of an existing structured narrative 400 from the structured narratives data store 205 requires sending to the at least one event and narrative server 103, a request for a complete or a partial structured narrative 400, which comprises in some embodiments a narrative-identifier 401 that specifies the structured narrative 400 to be retrieved and information indicating whether a complete or a partial structured narrative 400 is requested, and, if a partial structured narrative 400 is requested, then information indicating what portion of the structured narrative 400 is requested. An example of such a request in an embodiment is a request for the portion of the specified structured narrative 400 in which each event-reference 405 is associated with an importance-value 406 above a specified value. In some embodiments the request for a complete or a partial structured narrative 400 may result in returning all of the contents of some or all of the records of events 320 referenced by the event-references 405 within the specified structured narrative 400. Upon receiving a request for a complete or a partial structured narrative 400 the at least one event and narrative server 103 retrieves the requested structured narrative 400 from the structured narratives data store 205 and communicates it to the graphical user interface 100 as requested.

In some embodiments a user request for a complete or a partial record of an event 320, or a request for a complete or a partial structured narrative 400, communicated from a graphical user interface 100 to an at least one event and narrative server 103, may be accompanied by a indicator of a preferred language, such as Spanish. In these embodiments any definitional-media-elements 318, event-media-elements 325 and narrative-media-elements 407 that are returned to the user's graphical user interface 100 may be returned in the indicated preferred language, if they are available in that indicated preferred language.

In some embodiments a user can interact with structured narratives 400 that have been retrieved from the structured narratives data store 205, and with records of events 320 that have been retrieved from the records data store 202, by controlling the display of said structured narratives 400 and said records of events 320 using the at least one graphical user interface 100. Interaction may comprise the user controlling the display of records of events 320 using the importance-value 406 associated with those records of events 320 within the event-references 405 of a structured narrative 400. Interaction may comprise the user controlling the display of records of events 320 using a narrative-identifier 401 associated with a particular record of an event 320 within the event-references 405 of a structured narrative 400 to further retrieve a further structured narrative 400 (a detail-narrative) identified by the narrative-identifier 401 and further records of events 320 identified within the event-references 405 of the further structured narrative 400 (detail-narrative) identified by the narrative-identifier 401, and to display that structured narrative 400 and records of events 320 using the at least one graphical user interface 100.

In some embodiments a user can retrieve information about the noun-concepts 350 present in one or more records of events 320 from the noun-concepts data-store 203, and can display and interact with that noun-concept information using the at least one graphical user interface 100.

In some embodiments the executable code within the event and narrative server 103 may be configured to receive, from a graphical user interface 100, a request for a natural language text description of a specified structured narrative 400 identified by a specified narrative-identifier 401. In these embodiments, upon receiving such a request, the at least one event and narrative server 103 may retrieve the contents of records of events 320 associated with the specified structured narrative 400, and the contents of definitions of classes of events 310 and of noun-concepts 350 associated with each record of an event 320, and the contents of verb-concepts 300 associated with each definition of a class of events 310, and may use these contents to generate a natural language text description using instructions within the executable code that combine these contents, together with predetermined boilerplate text, using predetermined rules. An example of this in some embodiments is the combination of text noun-concept-descriptions 352 and natural language text phrases 314, in the unique order determined by the order of the event-roles 313 and the order of natural language text phrases 314 to form natural language text sentences, and the separation of those sentences with the predetermined boilerplate text “, and then” to form a complete natural language text description of the specified structured narrative 400. An example of such a natural language text description of a short structured narrative 400 with two records of events 320 is “[John Smith] spoke in support of [charter schools], and then [Bill Jones] strongly criticized [charter schools].”, in which the text noun-concept-descriptions 352 are enclosed in square brackets, the predetermined boilerplate text is underlined, and the remainder of the description comprises two natural language text phrases 314 from the definitions of classes of events 310 that define those two records of events 320.

In some embodiments in which users are uniquely identified, the specific users who cause the creation or modification of specific definitions of classes of events 310, or of specific records of events 320, or of specific structured narratives 400 are identified. In these embodiments a record is maintained of each unique user who contributes, by creation or by modification, to specific definitions of classes of events 310, or to specific records of events 320, or to specific structured narratives 400, and a degree is calculated, ranging from 0 to 100, of the contribution of each unique user to each specific definition of a class of events 310, or to each specific record of an event 320, or to each specific structured narrative 400. In some embodiments this calculation of the degree of contribution is as follows: each manner of contribution is assigned a value, such as 10 for creation of a record of an event 320, 3 for adding an event-media-element 325 to a record of an event 320, 4 for inserting a record of an event 320 into an event-reference 405 in a structured narrative 400, and so on. Total values for each user, for each manner of contribution and/or for each specific definition of a class of events 310, or for each specific record of an event 320, or for each specific structured narrative 400 are maintained by the at least one event and narrative server 103. The degree of contribution for a specific user for a specific manner of contribution for a specific definition of a class of events 310, or a specific record of an event 320, or a specific structured narrative 400 is then calculated as a simple percentage of the total values for each. In some embodiments the event and narrative server 103, upon receiving a request for a complete or a partial record of an event 320 or a complete or a partial structured narrative 400, returns user information comprising a list of users who have contributed to the requested record of an event 320 or requested structured narrative 400, and the degree to which, and manner in which they have contributed.

### Operation

### USE-CASE EXAMPLES

To illustrate some ways in which records of events 320 and structured narratives 400 can be used to facilitate common tasks in some embodiments, specific use-case examples of embodiments will now be described. In these embodiments, the at least one graphical user interface 100 may provide situation-specific interface tools (e.g., a “reporting tool”, a “news story interaction tool” and so on) to guide a user through these various scenarios as well as other scenarios, and the at least one event and narrative 103 may comprise executable code that provides instructions sufficient to enable the functioning of these tools. It is to be understood that these examples of embodiments are not intended to limit the scope of the present invention.

### Use-Case Example 1

### Reporting a News Story

The user advantageously begins by identifying a general narrative in the real world that is considered to be a news story and that is to be represented within the embodiment. The user then uses a reporting tool to create a new structured narrative 400, with a useful name for, and a description of, the news story, and then begins creating records of events 320 and inserting them into the new structured narrative 400. To create each new record of an event 320 the user first identifies a general event in the real world that is part of the news story and is to be represented as a record of an event 320 within the structured narrative 400. Using the reporting tool, the user creates a new record of an event 320 that identifies a definition of a class of events 310 with a verb-concept 300, event-activity and event-roles 313, and noun-concepts 350 to occupy each event-role 330, and time reference 323 and primary location noun-concept information such that the general event is accurately represented by the new record of an event 320. The user, or multiple different users, then continue to use the reporting tool to add additional records of events 320 representing additional general events within the news story to the structured narrative 400, without any necessary limit as to the number of records of events 320 or their distribution in time.

### Use-Case Example 2

### Interacting with a News Story

The user advantageously begins by retrieving a list of news story structured narratives 400 available within the structured narratives data store 205 using a news story interaction tool, and then selects a particular news story structured narrative 400 with which to interact. Upon selecting the particular news story structured narrative 400, the user is presented with a display of records of events 320 associated with that news story structured narrative 400 via its ordered plurality of event-references 404. Using the news story interaction tool the user may: choose different levels of detail, causing only records of events 320 associated with a specified importance-value 406 to be displayed; choose different forms of display using different forms of event-media-elements 325 associated with each record of an event 320, including event-media-elements 325 in different languages; choose to access additional records of events 320 expressing more detail within a detail-narrative associated with a particular record of an event 320; choose to display different lists of noun-concepts 350 associated with the records of events 320 within the structured narrative 400, and to display records of events 320 and other structured narratives 400 associated with these noun-concepts.

### Use-Case Example 3

### Recording a Fictional Story

The user advantageously begins by identifying or imagining a general narrative within a fictional story world that is to be represented within the embodiment. The user then uses a story-making tool to create a new structured narrative 400, with a useful name and a description, and begins creating records of events 320 and inserting them into the new structured narrative 400. To create each new record of an event 320 the user first identifies or imagines the general event in the fictional story world that is to be represented as a record of an event 320 within the structured narrative 400. Using the story-making tool, the user creates a new record of an event 320 that identifies a definition of a class of events 310 with a verb-concept 300, event-activity and event-roles 313, and noun-concepts 350 to occupy each event-role 330, and time reference 323 and primary location noun-concept information such that the general event is accurately represented by the new record of an event 320. The user, or multiple users, continue to use the story making tool to add additional records of events 320 representing additional general events within the identified or imagined general narrative, without any necessary limit to the number of records of events 320 or their distribution in time.

### Further Embodiments

While the invention has been described with respect to specific embodiments, one skilled in the art will recognize that numerous modifications are possible.

For example, in some embodiments it is possible to remove the ordering of the ordered event-roles 313 and to remove the ordering of the ordered natural language text phrases 314 from the definitions of classes of events 310, such that the event-roles 313 are unordered and the natural language text phrases 314 are unordered. These embodiments are easy to assemble because of the removal of the need to determine an order of event roles 313 and an order of natural language text phrases 314.

In some embodiments it is possible to introduce one or more additional layers of abstraction between the level of the verb-concept 300 and the level of the definition of a class of events 310. Each such an additional level describes layer-activity that is more constrained than verb-activity but that is less constrained than event-activity, and describes layer-roles that are more constrained than verb-roles 305 but less constrained than event-roles 330. In some of these embodiments the constraint of the layer-activity is achieved using a combination of specific semantic words and categories, and natural language phrases. The constraint of the layer-roles is achieved using a combination of additional categories of noun-concepts, including additional permitted-categories of noun-concepts.

A further example of a modification that would be recognized by one skilled in the art is the addition of one or more descriptive-elements (descriptive elements) to the definitions of classes of events 310, to the records of a class of event 320 and to the structured narratives 400, whereby the descriptive-elements convey additional information about how the records of events 320 and structured narratives 400 are to be presented when displayed on a graphical user interface 100, for example the attachment of an adjective descriptive-element that communicates a quality of a record of an event 320, or an adjective descriptive-element that communicates a quality of a structured narrative 400.

A further example of a modification that would be recognized by one skilled in the art is the use of Named Entity Recognition techniques, such as those provided by Open Calais or AlchemyAPI, to identify noun-concepts 350 from natural language text documents referring to a general event for use as noun-participants 340 within a record of an event 320 describing that general event. A further example of a modification that would be recognized by one skilled in the art is the use of Relation Extraction techniques, such as that provided by AlchemyAPI, to identify verbs 303 and verb-concepts 300 from natural language text documents referring to a general event for use in identifying possible definitions of classes of events 310 within which to create a record of an event 320 describing that general event.

A further example of a modification that would be recognized by one skilled in the art is the addition of one or more noun-descriptive-elements (noun descriptive elements) to noun-concepts 350 and to noun-categories 355, whereby the noun-descriptive-elements convey additional information about how the noun-concepts 350 are to be presented when displayed as part of a record of an event 320 on a graphical user interface 100, for example the attachment of an adjective noun-descriptive-element to a noun-concept 350 that communicates a quality of that noun-concept 350.

In some embodiments the verb-concepts data store 200, the noun-concepts data store 203, the definitional data store 201, the records data store 202, the structured narratives data store 205 and the narratives definitional data store 206, or a subset thereof, may all be at least one data store. In some embodiments the verb-concepts data store 200, the noun-concepts data store 203, the definitional data store 201, the records data store 202 and/or the structured narratives data store 205, or a subset thereof, may reside in the at least one event and narrative server 103.

In some embodiments the at least one graphical user interface 100 may be in direct contact with the at least one event and narrative server 103. In some embodiments the at least one graphical user interface 100 may be in communication with the at least one event and narrative server 103 over a network, including the Internet. In some embodiments the at least one graphical user interface 100 may reside in the at least one event and narrative server 103.

In addition, the invention has been described with reference to computer systems having particular hardware and software elements. It is to be understood that other systems with different combinations of hardware and/or software components could also be implemented.

Thus, although the invention has been described with respect to specific embodiments, it will be appreciated that the invention is intended to cover all modifications and equivalents within the scope of the following claims.

### CONCLUSION, RAMIFICATIONS AND SCOPE

Thus the reader will see that at least one embodiment of the present invention provides systems and methods for accurately capturing general events and general narratives as structured data within data stores, thereby explicitly defining the detailed activity, characters, entities, locations, information and the like that are referred to within those general narratives. The systems and methods therefore provide a practicable way of working with the fundamental components of narratives, also called stories, within computer systems. This is important because of the importance of narratives to human beings for recording, understanding and communicating information, and because the creation of, storage of and interaction with narratives have heretofore been possible only using units of natural language text and therefore have been subject to some limitations of units of natural language text.

The immediate advantages of this at least one embodiment of the present invention are many, and include without limitation: enabling structured narratives to be assembled of a size and complexity that exceed the size and complexity of narratives practicable using units of natural language text such as articles or books; enabling large and complex structured narratives to be easily assembled, navigated and consumed by multiple users via a graphical user interface, at different levels of detail as determined by chosen importance-values and by detail-narratives relating to general events of particular interest to the user, in different languages or in different media as determined by event-media-elements; enabling structured narratives and their components to be made accessible to computational techniques, that include search, systematic querying, machine learning and the like.

While my above description contains many specificities, these should not be construed as limitations on the scope, but rather as an exemplification of one embodiment thereof. Many other variations are possible, for example embodiments in which event-class-identifiers are replaced or complemented by equivalent information that is immediately present in the event record, embodiments in which other unique identifiers are replaced or complemented by equivalent information that is immediately present, embodiments in which the essential elements of verb-concepts and definitions of classes of events are combined, embodiments in which the group of possible event-media-elements include other and different structured data records.

Accordingly, the scope should be determined not by the embodiment illustrated, but by the appended claims and their legal equivalents.

What is claimed is:

1. A computer system for interacting with a plurality of general events and one or more general narratives as structured data, wherein the computer system comprises:
a. a definitional data store comprising a plurality of definitions of classes of events wherein the plurality of definitions of classes of events is non-transitorily held in definitional computer-readable media; and
b. a verb-concepts data store comprising a plurality of verb-concepts, wherein each verb-concept comprises:
i. a verb-concept-identifier uniquely identifying a verb-concept selected from the plurality of verb-concepts; and
ii. one or more verbs of similar meaning; and
iii. one or more verb-roles that participate in a verb-activity of said one or more verbs, each said verb-role uniquely identified by a verb-role-name;
wherein the plurality of verb-concepts is non-transitorily held in verb-concepts computer-readable media; and
c. a noun concepts data store comprising a plurality of noun-concepts wherein each noun-concept comprises:
i. a noun-concept-identifier uniquely identifying the noun-concept; and
ii. a noun-concept-description comprising a text description of the noun-concept; and
iii. one or more noun-categories of the noun-concept that organize the noun-concept within the plurality of noun-concepts;
wherein the plurality of noun-concepts is non-transitorily held in noun-concepts computer-readable media; and
d. a records data store comprising a plurality of records of events wherein each record of an event is non-transitorily held in records computer-readable media; and
e. a structured narratives data store comprising at least one structured narrative wherein the at least one structured narrative is non-transitorily held in a narratives computer-readable media; and
f. at least one event and narrative server networked to the definitional data store, to the verb concepts data store, to the noun concepts data store, to the records data store and to the structured narratives data store, wherein the at least one event and narrative server comprises: a processor, a network card, and memory; wherein the memory comprises non-transitory storage of executable code for instructing the processor; wherein the memory is in communication with the processor; wherein the network card is in communication with the processor and is configured to facilitate communication with the definitional data store, the verb concepts data store, the noun concepts data store, the records data store and structured narratives data store; and
g. at least one graphical user interface in communication with the at least one event and narrative server, wherein the at least one graphical user interface receives user inputs from a user and communicates said user inputs to the at least one event and narrative server permitting user interaction with at least one record of an event selected from the plurality of records of events stored in the records data store and with the at least one structured narratives stored within the structured narratives data store;
wherein the at least one event and narrative server's receipt of the user inputs causes the executable code to classify a general event per at least one definition of a class of events selected from the plurality of definitions of classes of events; and wherein the classified general event is stored as a record of that event; and wherein the at least one event and narrative server's receipt of the user inputs causes the executable code to define the one or more general narratives using references from the plurality of records of events as a structured narrative which is stored as one of the at least one structured narrative; and wherein the executable code further permits user interaction with said plurality of records of events and said at least one structured narrative, thereby permitting interaction with the general event and the at least one or more general narratives as structured data.

2. The computer system of claim 1, wherein each definition of a class of events selected from the plurality of definitions of classes of events comprises:
a. an event-class-identifier uniquely identifying the definition of a class of events; and
b. an event-class-description comprising a text description of the definition of a class of events; and
c. a particular verb-concept-identifier that uniquely identifies a particular verb-concept within the plurality of verb-concepts stored in the verb-concepts data store; and
d. one or more ordered event-roles, wherein each ordered event-role corresponds to one of the verb-roles within the verb-concept identified by the verb-concept-identifier and wherein each ordered event-role comprises:
i. a position of the ordered event-role in an order, wherein the order comprises a sequence of positions; and
ii. an event-role-name comprising a text name of the ordered event-role; and
iii. an event-role-identifier that uniquely identifies the ordered event-role within the definition of a class of events; and
iv. a verb-role-identifier that uniquely identifies a verb-role selected from the one or more verb-roles within the verb-concept identified by the verb-concept-identifier; and
v. a permitted-category of noun-concepts and a permitted-sub-categories of noun-concepts such that the permitted-category of noun-concepts is selected from the group comprising: a character noun-concept, an entity noun-concept, a location noun-concept, an information artifact noun-concept, a reference event noun-concept, a reference narrative noun-concept and a constant noun-concept, and the permitted-sub-categories of noun-concepts are selected from the one or more noun-categories associated with the plurality of noun-concepts; and
e. one or more ordered natural language text phrases that together and with said ordered event-roles describe an event-activity of the definition of a class of events, wherein each said ordered natural language text phrase follows one said ordered event-role in order such that said ordered natural language text phrases refer to said ordered event-roles, and wherein one said ordered natural language text phrase also comprises a single verb selected from the one or more verbs of similar meaning within the verb-concept identified by said verb-concept-identifier; and
f. one or more class-categories that organize the definitions of classes of events within the definitions data store by the verb-concept-identifier, by the natural language text phrases and by the permitted-category of noun-concepts and the permitted-sub-category of noun-concepts associated with one or more ordered event-roles within the definition of a class of events.

3. The computer system of claim 1, wherein each definition of a class of events selected from the plurality of definitions of classes of events further comprises at least one definitional-media-element, wherein each definitional-media-element is selected from one or more of the group comprising: at least one text bullet-point, at least one text summary, at least one image file, at least one video file, at least one audio file, at least one document file, and at least one web link.

4. The computer system of claim 1, wherein each record of an event selected from the plurality of records of events further comprises:
a. an event-record-identifier that uniquely identifies the record of an event; and
b. an event-class-identifier that uniquely identifies a definition of a class of events; and
c. one or more noun-participants, each noun-participant comprising:
i. a noun-participant-name comprising a text name of the noun-participant; and
ii. an event-role-identifier that uniquely identifies an ordered event-role within the definition of a class of events identified by the event-class-identifier; and
iii. a particular noun-concept-identifier uniquely identifying a particular noun-concept such that the particular noun-concept occupies the ordered event-role identified by said event-role-identifier and such that the particular noun-concept is a member of a permitted-category of noun-concepts and a permitted-sub-categories of noun-concepts associated with the ordered event-role identified by said event-role-identifier; and
d. a time reference, units of the time reference and a temporal duration for the time reference, representing a point in time and duration of the record of an event; and
e. a primary location noun-concept uniquely identifying a location noun-concept representing the primary location of the record of an event.

5. The computer system of claim 1, wherein each record of an event selected from the plurality of records of events further comprises at least one event-relationship, wherein each event-relationship comprises:
a. a second-event-record-identifier that uniquely identifies a second record of an event stored in the records data store such that a relationship exists between the record of an event and the second record of an event; and
b. a directional-indicator, indicating a direction of the relationship between the record of an event and the second record of an event; and
c. one or more relational-categories associated with the relationship between the record of an event and the second record of an event; and
d. a relational-description that describes the relationship between the record of an event and the second record of an event.

6. The computer system of claim 1, wherein each record of an event selected from the plurality of records of events further comprises at least one event-media-element, wherein the event-media-element is selected from one or more of the group comprising: at least one text bullet-point, at least one text summary, at least one image file, at least one video file, at least one audio file, at least one document file, and at least one web link.

7. The computer system of claim 1, wherein each record of an event selected from the plurality of records of events further comprises at least one event-media-reference, wherein the event-media-reference is selected from one or more of the group comprising: at least one text article, at least one web link, at least one document file, at least one video file, and at least one audio file.

8. The computer system of claim 1, wherein each structured narrative selected from the at least one structured narratives comprises:
a. a narrative-identifier uniquely identifying the structured narrative; and
b. a narrative-name comprising a text name of the structured narrative; and
c. a narrative-description comprising a text description of the structured narrative; and
d. an ordered plurality of event-references, wherein each ordered event-reference selected from the plurality of event references comprises:
i. an event-record-identifier uniquely identifying a record of an event; and
ii. an importance-value indicating an importance of said event-reference relative to other event-references within the structured narrative; and
iii. a narrative-identifier identifying a detail-narrative stored within the structured narratives data store.

9. The computer system of claim 1 wherein each structured narrative selected from the at least one structured narrative comprises at least one narrative-media-element, wherein each narrative-media-element is selected from one or more of the group comprising: at least one text bullet-point, at least one text summary, at least one image file, at least one video file, at least one document file, and at least one web link.

10. The computer system of claim 1, wherein the executable code, upon receiving a new definition of a class of events request and new definition of a class of events information, instructs the processor to create a new definition of a class of events, comprising the new information, non-transitorily stored within the definitional data store.

11. The computer system of claim 1, wherein the executable code, upon receiving a new event request and new event information, instructs the processor to create a new record of an event, comprising the new information, non-transitorily stored within the records data store.

12. The computer system of claim 1, wherein the executable code, upon receiving a new narrative request and new narrative information, instructs the processor to create a new structured narrative, comprising the new information, non-transitorily stored within the structured narratives data store.

13. The computer system of claim 1, wherein the executable code, upon receiving a event insertion request, event insertion information, an event-record-identifier and a narrative-identifier, instructs the processor to alter the structured narrative identified by said narrative-identifier to comprise an event-reference using the event-record identifier and the event insertion information.

14. The computer system of claim 1, wherein the executable code, upon receiving a request for a complete or a partial specified record of an event identified by a specified event-record-identifier, instructs the processor to return all or part of the information contained within the specified record of an event.

15. The computer system of claim 1, wherein the executable code, upon receiving a request for a complete or a partial specified structured narrative identified by a specified narrative-identifier, instructs the processor to return all or part of the information contained within the specified structured narrative.

16. The computer system of claim 1, further comprising a plurality of definitions of classes of narratives, wherein the plurality of definitions of classes of narratives is stored in a narrative definitional data store non-transitorily held in narrative definitional computer-readable media, and wherein each definition of a class of narratives comprises:
a. a narrative-class-identifier uniquely identifying the definition of a class of narratives; and
b. a plurality of event-class-identifiers, each uniquely identifying a definition of a class of events; and
c. one or more event-class-arrangements of said plurality of event-class-identifiers, each said event-class-arrangement comprising:
i. an ordering of some or all of the plurality of event-class-identifiers such that each event-class-identifier has a position in the order; and
ii. a narrative-percentage-value indicating a degree to which the event-class-arrangement represents the class of narratives represented by the definition of a class of narratives; and
iii. an event-class-percentage-value for each event-class-identifier within the event-class-arrangement, each event-class-percentage-value indicating a degree to which a record of an event defined by the definition of a class of events identified by the event-class-identifier is required to be present within said event-class-arrangement in order to represent the class of narratives represented by said definition of a class of narrative; and
iv. one or more noun-concept-percentage-value for each event-role within the definition of a class of events identified by each event-class-identifier within the event-class-arrangement, each said noun-concept-percentage-value indicating a degree to which a particular noun-concept or a category of noun-concepts is required to occupy an ordered event-role within the definition of a class of events identified by the event-class-identifier in order to represent said definition of a class of narrative; and
v. a primary-location-percentage-value for each event-class-identifier within the event-class-arrangement, each said primary-location-percentage-value indicating a degree to which a particular location noun-concept, a category of location noun-concepts or a geographic arrangement of location noun-concepts is required to be present within the event-class-arrangement in order to represent said definition of a class of narrative; and
vi. time-reference-percentage-values for each event-class-identifier within the event-class-arrangement, each time-reference-percentage-value indicating a degree to which a particular time reference or a sequence of time references is required to be present within the event-class-arrangement in order to represent the definition of a class of narrative; and
wherein each structured narrative held within the structured narratives data store is associated with one or more definitions of classes of narratives held within said narrative definitional data store.

17. The computer system of claim 16, wherein the executable code within the event and narrative server instructs the processor to:
a. identify narrative patterns by comparison with predetermined patterns, each narrative pattern comprising:
i. class arrangements, within existing structured narratives, of records of events that are defined by particular definitions of classes of events; and
ii. role arrangements, within existing structured narratives, of records of events that comprise event-roles that are occupied by particular noun-concepts and by particular categories of noun-concepts; and
iii. location noun-concept arrangements, within existing structured narratives, of records of events that comprise particular location noun-concepts or geographic arrangements of location noun-concepts; and
iv. temporal arrangements, within existing structured narratives, of records of events that comprise particular sequences of time references; and
b. create new definitions of classes of narratives using said identified narrative patterns as a basis for the new definitions of classes of narratives; and
c. automatically create new structured narratives using said new definitions of classes of narratives and using pluralities of event-references identifying existing records of events; and
d. automatically calculate, using the event-class-percentage-values, the noun-concept-percentage-values, the primary-location-percentage-values and the time-reference-percentage-values, a percentage probability that an unspecified record of an event of a particular definition of a class of events, with event-roles occupied by a particular noun-concept or the one or more categories of noun-concept, with a particular location noun-concept, or category of location noun-concepts, or with a particular time reference will be inserted into a particular structured narrative.

18. The computer system of claim 1, wherein each event and narrative server is networked to an external non-transitory data store or to an external source of signals and wherein said executable code within said event and narrative server, upon receiving notification of changes in said non-transitory data store or receiving a signal from said source of signals, instructs the processor to:
a. create a new record of an event, said new record of an event being defined by a predetermined definition of a class of events and created using information from said change in said non-transitory data store or from said signal; and
b. insert an event-reference identifying said new record of an event into a new or an existing structured narrative.

19. The computer system of claim 1, wherein said executable code makes accessible to a computer in communication, using a computer network, with the at least one event and narrative server:
a. an event-record-identifier and other contents of each record of an event stored in the records data store, wherein a user or a computer can use said event-record-identifier to uniquely identify said record of an event on said computer network; and/or
b. a narrative-identifier and other contents of each structured narrative stored in the narratives data store, wherein a user or a computer can use said narrative-identifier to uniquely identify said structured narrative on said computer network.

20. The computer system of claim 1, wherein said records data store is configured to store a plurality of records of events in which the particular computer system implementing the present invention is itself represented as a noun-concept in ordered event-roles within said records of events, whereby said computer system can store records of events about itself and structured narratives about itself in the context of other records of events and other noun-concepts.

21. The computer system of claim 1, wherein particular records of events and particular structured narratives are created by an operator of said computer system in exchange for remuneration.

22. The computer system of claim 1, wherein the executable code, upon receiving a request for a natural language text description of a specified structured narrative identified by a specified narrative-identifier, instructs the processor to combine elements of definitions of classes of events associated with said specified structured narrative, and elements of records of events associated with said structured narrative, and boilerplate natural language text phrases as predetermined by the combination of said elements, into a single natural language text describing the specified structured narrative.

23. A computer-implemented method for interacting with a plurality of general events and one or more general narratives as structured data, comprising steps of:
a. defining a definition of a class of events, wherein each defined definition of a class of events is aggregated into a plurality of definitions of classes of events, wherein the plurality of definitions of classes of events comprises a definitional data store, wherein each definition of a class of events is non-transitorily held in definitional computer-readable media; and
b. defining a verb-concept, wherein each defined verb-concept is aggregated into a plurality of verb-concepts, wherein the plurality of verb-concepts comprises a verb-concepts data store, wherein each verb-concept is defined by:
i. creating a verb-concept-identifier that uniquely identifies the verb-concept; and
ii. selecting one or more verbs of similar meaning and associating said one or more verbs with the verb-concept; and
iii. selecting one or more verb-roles that participate in a verb-activity conveyed by said one or more verbs, and defining a unique a verb-role-name that identifies each verb-role and associating said one or more verb-roles with the verb-concept; and
wherein the verb-concepts data store is non-transitorily held in verb-concepts computer-readable media; and
c. defining a noun-concept, wherein each defined noun-concept is aggregated into a plurality of noun-concepts, wherein the plurality of noun-concepts comprises a noun-concepts data store, wherein each noun-concept is defined by:
i. creating a noun-concept-identifier that uniquely identifies the noun-concept; and
ii. creating a noun-concept-definition comprising a text description of said noun-concept and data required to describe the noun-concept; and
iii. selecting one or more noun-categories of noun-concepts and associating said selected one or more noun-categories with the noun-concept;
wherein the noun-concepts data store is non-transitorily held in noun-concepts computer-readable media; and
d. defining a record of an event, wherein each defined record of an event is aggregated into a plurality of records of events, wherein the plurality of records of events comprises a records data store, wherein each defined record of an event is non-transitorily held in records computer-readable media; and
e. defining a structured narrative, wherein each defined structured narrative is aggregated into a plurality of structured narratives, wherein the plurality of structured narratives comprises a structured narratives data store, wherein each defined structured narrative is non-transitorily held in narratives computer-readable media; and
wherein each definition of a class of events is associated with a verb-concept and wherein individual general events are each represented as a record of an event stored within the records data store and defined by a definition of a class of events and comprising references to noun-concepts, and wherein general narratives are represented by structured narratives stored within the structured narratives data store and comprising a plurality of references to records of events, and wherein interaction with said records of events and said structured narratives thereby enables interaction with said general events and general narratives as structured data.

24. The method of claim 23, wherein defining each definition of a class of events comprises the steps of:
a. generating an event-class-identifier that uniquely identifies said definition of a class of events; and
b. creating an event-class-description comprising a text description of the definition of a class of events; and
c. selecting a particular verb-concept-identifier that uniquely identifies a verb-concept within the verb-concept data store; and
d. defining one or more ordered event-roles, wherein each said ordered event-role corresponds to a verb-role within the verb-concept identified by said verb-concept-identifier and comprising further steps of:
i. defining a position of the ordered event-role in the order; and
ii. defining an event-role-name comprising a text name of the event-role; and
iii. defining an event-role-identifier that uniquely identifies the ordered event-role within the definition of a class of events; and
iv. selecting a verb-role-identifier that uniquely identifies a specific verb-role within the verb-concept identified by said verb-concept-identifier; and
v. Selecting a permitted-category or noun-concepts and a permitted-sub-categories of noun-concepts such that the permitted-category of noun-concepts is selected from the group comprising: a character noun-concept, an entity noun-concept, a location noun-concept, an information artifact noun-concept, an reference event noun-concept, a reference narrative noun-concept and a constant noun-concept, and the permitted-sub-categories of noun-concepts are selected from the one or more noun-categories associated with the plurality of noun-concepts; and
e. defining one or more ordered natural language text phrases that together and in combination with said one or more ordered event-roles describe an event-activity of the definition of a class of events, each said ordered natural language text phrase following one said ordered event-role in order such that said ordered natural language text phrases refer to said one or more ordered event-roles, and one said ordered natural language text phrase also comprising a single verb within the verb-concept identified by said verb-concept-identifier; and
f. selecting one or more class-categories that organize the definition of a class of events by the verb-concept-identifier, by the natural language text phrases and by the permitted-category of noun-concept and the permitted-sub-category of noun-concepts associated with one or more ordered event-roles within the definition of a class of events.

25. The method of claim 23, wherein defining each definition of a class of events comprises the further step of associating definitional-media-elements with said definition of a class of events, wherein each definitional-media-element is selected from one or more of the group comprising: at least one text bullet-point, at least one text summaries, at least one image file, at least one video file, at least one audio file, at least one document file, and at least one web link.

26. The method of claim 23, wherein defining each record of an event comprises the further steps of:
a. defining an event-record-identifier that uniquely identifies the record of an event; and
b. defining an event-class-identifier that uniquely identifies a definition of a class of events; and
c. defining one or more noun-participants, wherein defining each noun-participant comprises steps of:
i. defining a noun-participant-name comprising a text name of the noun-participant; and
ii. selecting an event-role-identifier that uniquely identifies an ordered event-role within the definition of a class of events identified by the event-class-identifier; and
iii. selecting a particular noun-concept-identifier uniquely identifying a particular noun-concept such that said particular noun-concept occupies the ordered event-role identified by the event-role-identifier and such that the particular noun-concept is a member of a permitted-category of noun-concepts and a permitted-sub-categories of noun-concepts associated with the ordered event-role identified by the event-role-identifier; and
d. defining a time reference, units of the time reference and a duration for the time reference, representing a point in time and duration of the record of an event; and
e. defining a primary location noun-concept which uniquely identifies a location noun-concept representing the primary location of the record of an event.

27. The method of claim 23, wherein defining the record of an event also comprises the further step of defining event-relationships, wherein defining each event-relationship comprising steps of:
a. selecting a second-event-record-identifier that uniquely identifies a second record of an event stored in the records data store such that a relationship exists between the record of an event and the second record of an event; and
b. defining a directional-indicator, indicating a direction of the relationship between the record of an event and the second record of an event; and
c. selecting one or more relational-categories associated with the relationship between the record of an event and the second record of an event; and
d. defining a relational-description that describes the relationship between the record of an event and the second record of an event.

28. The method of claim 23, wherein defining each record of an event comprises the further step of selecting event-media-elements and associating said event-media-elements with said record of an event, wherein each event-media-element is selected from one or more of the group comprising: at least one text bullet-point, at least one text summary, at least one image file, at least one video file, at least one audio file, at least one document file, and at least one web link.

29. The method of claim 23, wherein defining each record of an event comprises the further step of selecting event-media-reference and associating said event-media-reference with said record of an event, wherein each event-media-reference is selected from one or more of the group comprising: at least one text article, at least one web link, at least one document file, at least one video file, and at least one audio file.

30. The method of claim 23 wherein defining each structured narrative comprises the steps of:
a. generating a narrative-identifier that uniquely identifies the structured narrative; and
b. creating a narrative-name comprising a text name of the structured narrative; and
c. creating a narrative-description comprising a text description of the structured narrative; and
d. defining an ordered plurality of event-references wherein each event-reference is defined by steps comprising of:
i. selecting an event-record-identifier that uniquely identifies a record of an event; and
ii. selecting an importance-value indicating an importance of said event-reference relative to other event-references within the structured narrative; and
iii. selecting a narrative-identifier which identifies a detail-narrative stored within the structured narrative data store.

31. The method of claim 23, wherein defining each structured narrative comprises the further step of defining one or more narrative-media-elements, wherein each narrative-media-element is selected from one or more of the group comprising: at least one text bullet-point, at least one text summary, at least one image file, at least one video file, at least one audio file, and at least one web link.

32. The method of claim 23, wherein upon receiving a new definition of a class of events request and new definition of a class of events information, the method further comprises the step of creating a new definition of a class of events non-transitorily stored in the definitional data store.

33. The method of claim 23, wherein upon receiving a new record of an event request and new record of an event information, the method further comprises the step of creating a new record of an event non-transitorily stored in the records data store.

34. The method of claim 23, wherein upon receiving a new narrative request and new narrative information, the method further comprises the step of creating a new structured narrative non-transitorily in the structured narratives data store.

35. The method of claim 23, wherein upon receiving an event insertion request, event insertion information, an event-record-identifier and a narrative-identifier, the method further comprises the step of altering the structured narrative identified by said narrative-identifier to comprise an event-reference using said event-record-identifier and said event-insertion-information.

36. The method of claim 23, wherein upon receiving a request for a complete or a partial specified record of an event identified by a specified event-record-identifier, the method further comprises the step of returning all or part of the information contained within said specified record of an event.

37. The method of claim 23, wherein upon receiving a request for a complete or a partial record of a specified structured narrative identified by a specified narrative-identifier, the method further comprises the step of returning all or part of the information contained within said specified narrative.

38. The method of claim 23, wherein upon receiving a new record of an event request and new record of an event information, the method further comprises the steps of:
a. providing a list of verbs wherein the list of verbs is assembled from the one or more verbs of similar meaning associated with each of the plurality of verb-concepts; and
b. receiving at least one verb selected from said list of verbs; and
c. returning a list of definitions of classes of events associated with verb-concepts containing said selected verb; and
d. receiving at least one definition of a class of events selected from said list of definitions of classes of events; and
e. returning a list of event-roles contained within said selected definitions of classes of events and a list of noun-concepts selected from a permitted-category of noun-concepts and a permitted-sub-categories of noun-concepts associated with each event-role within the list of event-roles; and
f. receiving at least one noun-concept for each event-role within the list of event-roles, selected from the list of noun-concepts associated with said event-role; and
g. receiving at least one of: a location noun-concept, a time reference, an event-media-element, an event-media-reference and an event-relationship associated with said new record of an event; and
h. subsequently creating a new record of an event within the records data store, whereby the creation of said new record of an event is achieved solely by selecting from lists and without writing in natural language.

39. The method of claim 23, wherein the method further comprises the steps of:
a. upon receiving a new record of an event request and new record of an event information, the method further comprises steps of translating, by a human or automated translator, event-media-elements expressed in natural language and contained in said new record of an event information into other languages, and storing each translation of each received event-media-element as an additional event-media-element associated with the new record of an event information and resulting new record of an event within the records data store; and
b. upon receiving a request for a complete or a partial specified record of an event identified by a specified event-record-identifier and receiving an indicator of a preferred language, to return event-media-elements comprised within the specified record of an event specified by the event-record-identifier in the specified preferred language.

40. The method of claim 23, wherein the method further comprises the step of receiving display instructions specifying the manner in which a specified record of an event identified by event-references within a specified structured narrative are to be displayed on a graphical user interface, wherein the method requests the graphical user interface to display the specified record of an event according to at least one of the following:
a. displaying the specified record of an event based on an importance-value of the event-reference associated with the specified record of an event within said specified structured narrative; and
b. displaying the specified record of an event based on a detail-narrative identified by the narrative-identifier of an event-reference associated with the specified record of an event within said specified structured narrative; and
c. displaying the specified record of an event based on an event-media-element associated with the specified record of events; and
d. displaying the specified record of an event based on an event-media-reference associated with the specified record of events; and
e. displaying the specified record of an event based on an event-relationship associated with the specified record of an event; and
f. displaying the specified record of an event based on the noun-concepts and the verb-concepts associated with the specified record of an event.

41. The method of claim 23, wherein the method upon receiving at least one received specified element returns any record of an event held in the records data store, or in any subset of the records data store, that comprises elements that match one or more of the received specified elements; wherein each received specified element comprises one or more of the following:
a. a specified time reference, or an interval between specified time references, that is part of the definition of the record of an event; and
b. a specified geographic location that corresponds to a location noun-concept that is part of the definition of a record of an event; and
c. a specified noun-concept that is part of the definition of an event-role within a record of an event; and
d. a specified category of noun-concept or specified sub-category of noun-concept that is part of the definition of an event-role within a record of an event; and
e. a specified verb or specified verb-concept that is part of a definition of a class of events that is used to define a record of an event; and
f. a specified relational-category of event-relationship that is part of the definition of a record of an event; and
g. a specified category of a definition of a class of event, or a specified category of record of an event or a specified category of structured narrative.

42. The method of claim 23, wherein the method further comprises the steps of:
a. receiving a request comprising one or more verbs; and
b. returning a list of definitions of classes of events that are defined using verb-concepts associated with said one or more verbs;
whereby the method receives a selection of definitions of classes of events selected from the returned list of definitions of classes of events.

43. The method of claim 23, wherein the method further comprises the steps of:
a. uniquely identifying each user who provides inputs to the method via a graphical user interface; and
b. identifying each uniquely identified user who causes the creation or modification of any: definition of a class of events, record of an event, and structured narrative; and
c. calculating a degree to which, and a manner in which, each said uniquely identified user has cumulatively contributed to each definition of class of events, each record of event, and each structured narrative; and
d. returning, in response to requests for records of events and requests for narratives, a list of uniquely identified users who have contributed to said requested records of events or said requested structured narratives and the degree to which, and the manner in which, said users have contributed;
wherein the method causes a display of said records of events or said structured narratives on a graphical user interface and also displays user information wherein the user information comprises information of said uniquely identified users who have contributed to said records of events or to said structured narratives and the degree to which, and the manner in which, said users have contributed.
